(19) United States
(12) Patent Application Publication
(10) Pub. No.: US 2024/0386813 A1
(43) Pub. Date: Nov. 21, 2024

(54) SPEECH RECOGNITION TECHNOLOGY SYSTEM FOR DELIVERING SPEECH THERAPY

(71) Applicant: SAY IT Labs, BV, Kessel-Lo (BE)

(72) Inventors: Lukas LATACZ, Kessel-Lo (BE); Erich REITER, East Amherst, NY (US)

(21) Appl. No.: 18/669,096

(22) Filed: May 20, 2024

Related U.S. Application Data
(60) Provisional application No. 63/503,260, filed on May 19, 2023.

(51) Int. Cl. G09B 19/04; G10L 15/02; G10L 25/03; G10L 25/30

(52) U.S. Cl. CPC G09B 19/04; G10L 15/02; G10L 25/03; G10L 25/30

(57) ABSTRACT

A computer-based speech recognition technology system for delivering speech therapy having designed to, substantially in real time, capture, process, and analyze audio voice signals and generate speech parameters to offer to users based on speech data supported by one machine learning designed to provide users with reports, the reports designed to provide at least one score through which to aid users at improving speaking performance. The score includes at least one variable indicating at least one or more of: pitch, rate of speech, speech intensity, shape of vocal pulsation, voicing, magnitude profile, pitch, pitch strength, phonemes, rhythm of speech, harmonic to noise values, cepstral peak prominence, spectral slope, shimmer, and jitter; and score assessments including measures from at least one or more linguistic rules from a group of: phonology, phonetics, syntactic, semantics, and morphology.

### CROSS-REFERENCE TO RELATED APPLICATIONS

This application claims priority pursuant to 35 U.S.C. 119(e) to U.S. Provisional Application No. 63/503,260, filed May 19, 2023, which application is incorporated herein by reference in its entirety.

### FIELD OF THE INVENTION

The present invention generally relates to speech recognition technology. and more specifically, relates to a speech recognition technology system arranged for delivering speech therapy.

### BACKGROUND

A speech motor exercise is a type of exercise that the user has to perform using their voice. Motor learning (Nieuwboer, Rochester, Muncks, & Swinnen, 2009) is generally defined as a set of processes aimed at learning and refining new skills by practicing them. It is the process of learning movements by practicing these movements.

By practicing the movements of speech, the user learns these movements and this could result in a permanent change (which means the user has learned how to perform the excise) but more importantly it could also lead to generalization of related movements. The latter is very important and relevant in a therapeutic context for speech and language rehabilitation. These types of exercises are therefore useful for all the subcomponents of speech production such as articulation, breathing (Solomon & Charron, 1998), prosody and voice.

The scope of speech exercises is not limited to only improving the actual production of speech. Overt speech is the most observable aspect of human communication (Levelt, 1989). Language disorders, hearing disorders, literacy, neurodivergent traits and cognitive impairments can be detected—to a certain extend—through inappropriate speech patterns. This means the invention can also rehabilitate these conditions using speech exercises and monitor progress and give feedback based on the speech patterns produced during the exercise.

One of the two most important concepts of motor learning are intensity (see for example Breitenstein et al, 2017) and feedback. These concepts are hard to implement well in the clinical practice because duration and the number of therapy session per week is limited and relevant clinical feedback during exercises is limited to these therapy sessions as these require a speech and language pathologist to be present.

Motivation or the willingness to spend time and effort to practice speech and languages skills is another reason why it is difficult to implement an intensive therapy program in practice.

Speech and Language Pathologists (hereinafter “SLPs”) are the current gold standard of delivering speech services. SLPs offer both live in-person and online therapy. Typical sessions last one time per week for an average of 45 minutes. Of the roughly 200k SLPs practicing in the United States, less than 1% specialized in the treatment of stuttering therapy. It is impossible for the roughly 3000 SLPs who provide stuttering therapy to the over 3 million people who stutter in the United States.

Self-help groups were born out of this frustration to seek stuttering treatment since proper access to treatment is rare to find. The national stuttering association therefore started a movement know as, ‘speak freely’. The philosophy of this treatment is simply accepting the stutter, and telling society that the problem with stutter is on it, and not on the direct need of the person who stutters to seek communication strategies.

Stamurai (http://stamurai.com): Stamurai is a mobile app that helps people who stutter learn and practice fluency shaping techniques and some stuttering modification exercises for people who stutter. The main developers are people who stutter themselves and have implemented a fun app that encourages daily practice. This is not a video game, but has very nice scaffolding techniques and gamification. The cost of the app is roughly $100/year or $25/month.

Benetalk uses speech recognition technology to help track the rate of speech of people who stutter. It also has its own online community where users of the Benetalk app, who are people who stutter, can ask questions and connect with other members of the Benetalk community. The game was developed by engineers who stutter.

Speech Again (https://www.speechagain.com): Based out of Berlin, Germany, Speech Again offers an online-only stuttering therapy as an alternative to traditional speech therapy. Instead of going to a speech therapist, online exercises are provided directly to the client where they can practice the self-assessed speech goals. With their recent launch in the United States (November 2018), they are aiming to penetrate the U.S. market.

SpeechEasy (https://speecheasy.com): The SpeechEasy is a wearable device intended for people with Parkinson's disease. It looks like a hearing aid, but when you wear the device, the user hears their own voice with an alternative pitch, both in delay, which creates a ‘choral effect’ 40. The choral effect helps people slow down their rate of speech and alter their pitch, both positive effects to reduce stuttering. They are based out of Colorado, United States.

mpi2 (http://www.mpi2.com): Modifying Phonation Intervals (mpi) out of Sydney, Australia is based on Professor Roger Ingham's work on stuttering therapy. He uses a hybrid therapy/app approach. The biofeedback app gives feedback when PWS are incorrectly using their vocal folds during therapy. The program is mostly adult oriented, although it is applicable for mature young adults.

BumpFree (App Store). The BumpFree app is a digital companion to a therapy treatment out of Australia, Lidcombe. Lidcombe is a program that requires parent involvement. The App is a digital paper that requires parents to enter whenever their child produces a stuttering event. The idea is to track stuttering events over time to help children become mindful of their stuttering, what events may trigger increased disfluencies, and to help with the desensitization of stuttering.

Speech Blubs is a speech therapy app that uses voice controlled and video technology to develop speech articulation for young children with or without speech difficulties. It uses speech recognition technology on single words but does not provide feedback during a failed production. Scaffolding is limited to how a word should sound, without offering any techniques on how to produce the sound.

The aforementioned examples, or solutions, are not optimal for several reasons. In the case of SLPs, the frequency of therapy is not intensive enough. If SLPs could offer daily therapy to all of their clients, it would likely suffice to have SLPs as the sole provider of speech therapy. The population growth rate however is faster than the number of SLPs graduating. This will result in fewer SLPs to provide services for a greater number of clients in the future.

Self-help groups do not offer traditional therapy. Instead, they offer emotional support and community for people of a common disorder.

For the Apps (Stamurai, Bumpfree, mpi2, Benetalk, speech blubs), they offer some independent practice because all of these apps have technology that provides some level of feedback. For example, Speech Blubs uses automatic speech recognition allowing users to use their voice as input. This system is however limited because feedback is never given upon failure. Clients therefore do not know how to repair their input. In all cases of the Apps, either feedback is slow, not present, or requires the interpretation of an actual person that can offer verbal guidance on how to progress. True independent practice is limited.

Finally, the only hardware solution, is a delayed auditory feedback (hereinafter “DAF”) device. The SpeechEasy is an example of an already saturated field. DAF is a technology that plays back just-spoken audio. Typically, it is worn in the ear and resembles a hearing air. When a person speaks, they hear an echo of their own voice through the DAF device. The benefit is that it helps people with speech disorders speech more slowly which generally supports increased fluency and intelligibility. The drawback of the DAF is that it places high demands on cognitive processes, in particular, during a conversation. The experience is that a person must simultaneously hear their delayed voice being echoed back into their ear while at the same time, they must focus on the content of their conversational partners. This demands and capacity model makes it nearly impossible to have a sophisticated conversation, keeping interactions superficial at best.

Therefore, there is a long-felt need for a system that is arranged to implement changes in the behavior, emotions, or thoughts, of a user, by modifying neurological pathways through practicing speech motor exercises.

### SUMMARY

The main purpose of the invention is to change the behavior, emotions or thoughts of the user of the invention by modifying neurological pathways through practice of speech motor exercises implemented by the system of the invention.

The invention includes a system having a processor system operating as at least one or more speech processors designed to analyze input audio voice signals and generate speech parameters, a feedback processor designed to convert measurements generated by the speech processor into speech data, the processor designed to present one or more interactive speech exercises to users based on the speech data, and the processor designed to store the speech data.

The system may include the aforementioned processor system and further comprises at least one software program, the software program including at least one machine learning algorithm designed to receive speech data from the processor, the machine learning algorithm designed to provide users with reports, the reports designed to provide at least one score through which to aid users at improving speaking performance.

In some embodiments, the invention may comprise a speech recognition technology system for delivering speech therapy, the system comprising at least one processor system, at least one memory system, and at least one user interface disposed on at least one user computer system, the user computer system designed to be operationally coupled to at least one server computer system; at least one input system disposed on the user computer system designed to, substantially in real time, capture, process, and analyze audio voice signals; a processor system disposed on at least one or more of the user computer system and the server computer system, the processor system operating as at least one or more of a speech processor designed to analyze input audio voice signals and generate speech parameters, a feedback processor designed to convert measurements generated by the speech processor into speech data, the processor designed to present one or more interactive speech exercises to users based on the speech data, and the processor designed to store the speech data; at least one software program disposed on the at least one or more of the user computer system and the server computer system, the software program including at least one machine learning algorithm designed to receive speech data from the processor, the machine learning algorithm designed to provide users with reports, the reports designed to provide at least one score through which to aid users at improving speaking performance; the score including at least one variable indicating at least one or more of: pitch, rate of speech, speech intensity, shape of vocal pulsation, voicing, magnitude profile, pitch, pitch strength, phonemes, rhythm of speech, harmonic to noise values, cepstral peak prominence, spectral slope, shimmer, and jitter; and score assessments including measures from at least one or more linguistic rules from a group of: phonology, phonetics, syntactic, semantics, and morphology.

In some embodiments, the aforementioned speech data may include at least one vector having positional, directional, and magnitude measurements.

In other embodiments, the aforementioned user computer system and the server computer system may be designed to operate as an edge computing system, further having at least one edge node and at least one edge data center.

In some embodiments of the speech recognition technology system for delivering speech therapy, further including speech processor arranged to analyze input speech and to output various speech and language parameters, including a processor, the processor arranged with an automatic speech recognition model, the automatic speech recognition model to be loaded with at least one of: a language model and an acoustic model. In some embodiments of the speech recognition technology system for delivering speech therapy, along with a microphone in communication with the processor, wherein the microphone is arranged to collect audio inputs and output the audio inputs to the processor in sequences.

Some embodiments of the speech recognition technology system for delivering speech therapy have a plurality of processing layers, each of the plurality of processing layers having at least one processing module. In some embodiments of the speech recognition technology system for delivering speech therapy, one of the plurality of processing layers includes a converting layer arranged to convert the output of the microphone into a representation accepted by the processor system. In some embodiments of the speech recognition technology system for delivering speech therapy, one of the plurality of processing layers includes: a speech enhancement layer including an algorithm arranged to provide at least one of: automatic gain control, noise reduction, and, acoustic echo cancellation.

In some embodiments of the speech recognition technology system for delivering speech therapy, at least one noise reduction algorithm is designed to filter speech data. Some embodiments of the speech recognition technology system for delivering speech therapy further use a neural network designed to predict which parts of spectrums to attenuate. In some embodiments of the speech recognition technology system for delivering speech therapy, an automatic speech recognition module is designed to predict a sequence of text items in real time wherein the text predictions are updated based on results and variance from predictions. In some embodiments, the user interface is designed to provide feedback by way of text, color, and movable images, which themselves may present games wherein users/players may compete against a standard, themselves, or other people.

Generally, the invention is software that runs on a standalone computer, or mobile device, and that allows the user to practice speech motor exercises in which real-time feedback on the produced speech is given. This feedback is generated automatically without any human intervention which allows the user to practice at home, independently.

Each embodiment of the invention is suited for one or more speech or language disorders or other disorders which are neurological in nature such as hearing disorders, literacy, neurodivergent traits or cognitive impairments.

### BRIEF DESCRIPTION

Various embodiments are disclosed, by way of example only, with reference to the accompanying schematic drawings in which corresponding reference symbols indicate corresponding parts, in which:

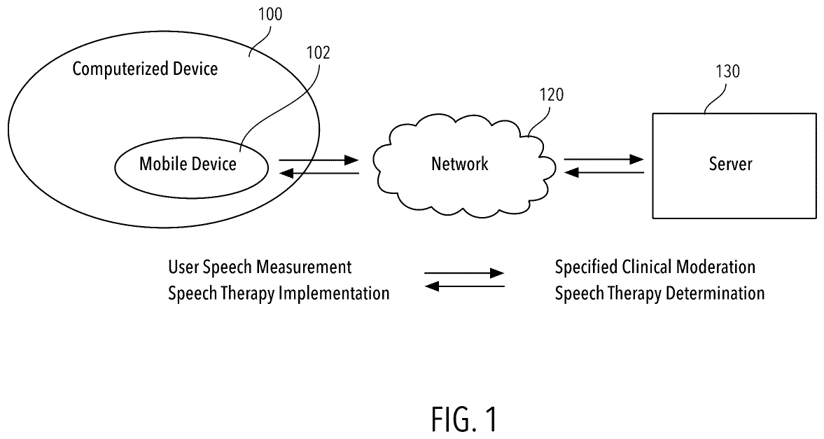

FIG. 1 generally illustrates a high-level flow schematic of the invention;

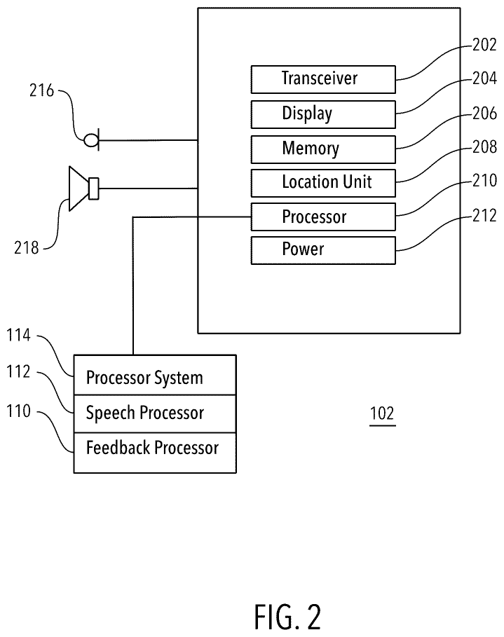

FIG. 2 generally illustrates an exemplary embodiment of a mobile device of the invention;

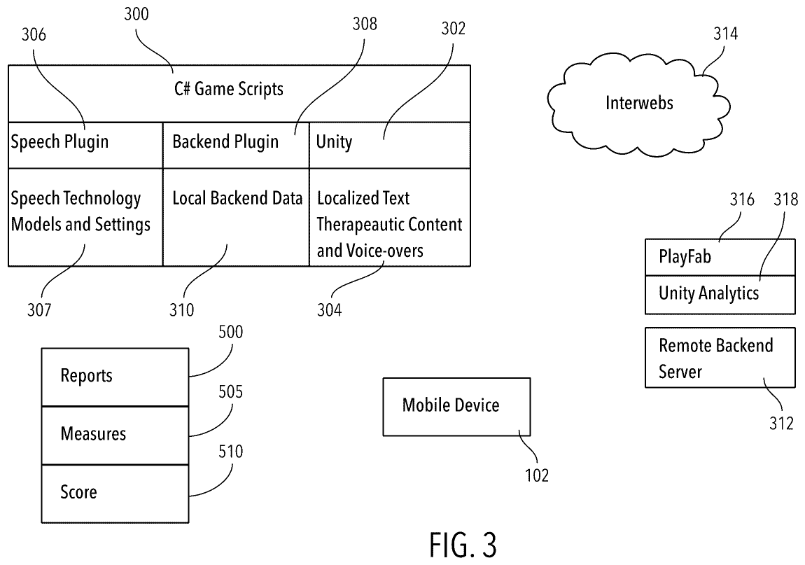

FIG. 3 generally illustrates a high-level schematic of a game development platform of the invention;

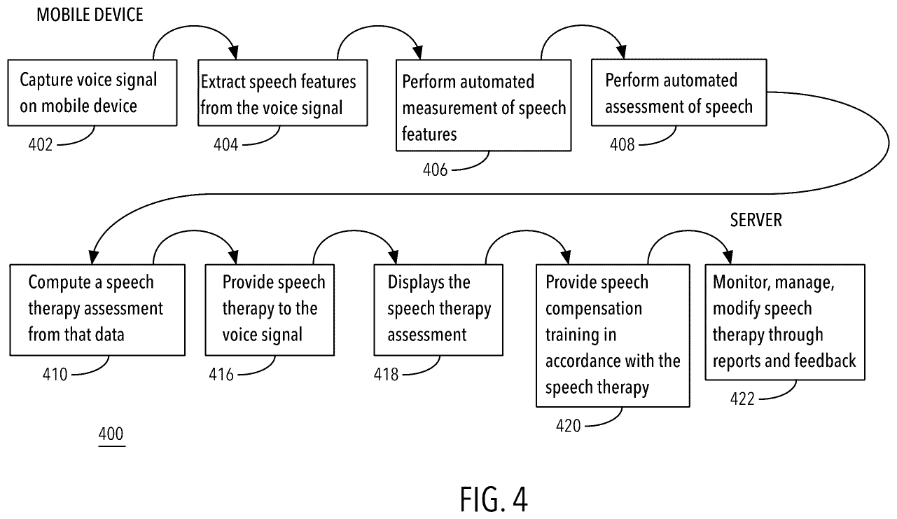

FIG. 4 generally illustrates a method for providing speech therapy of the invention;

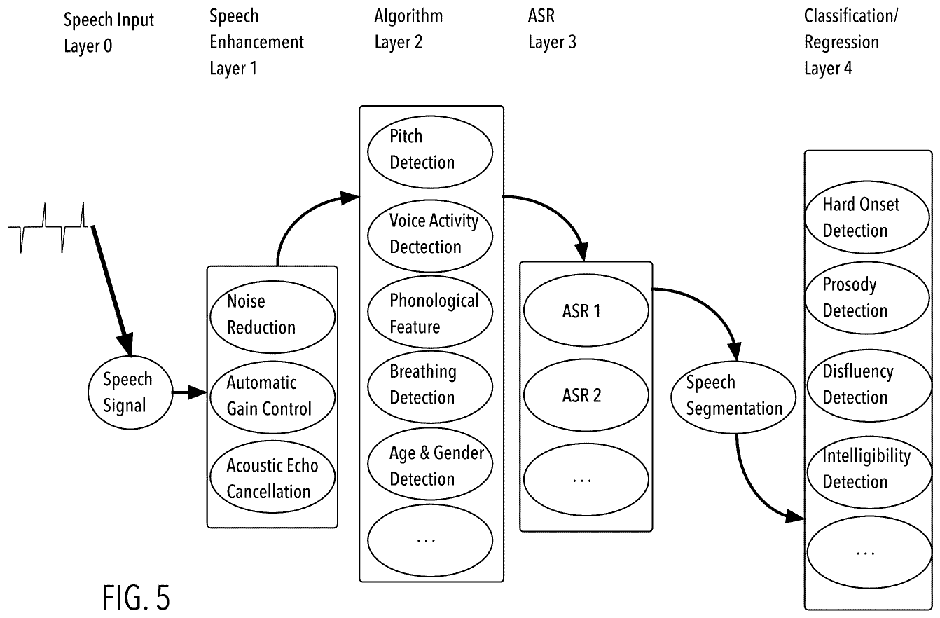

FIG. 5 generally illustrates a flow diagram concerning structuring data for analysis within at least one of an algorithm of the invention; and,

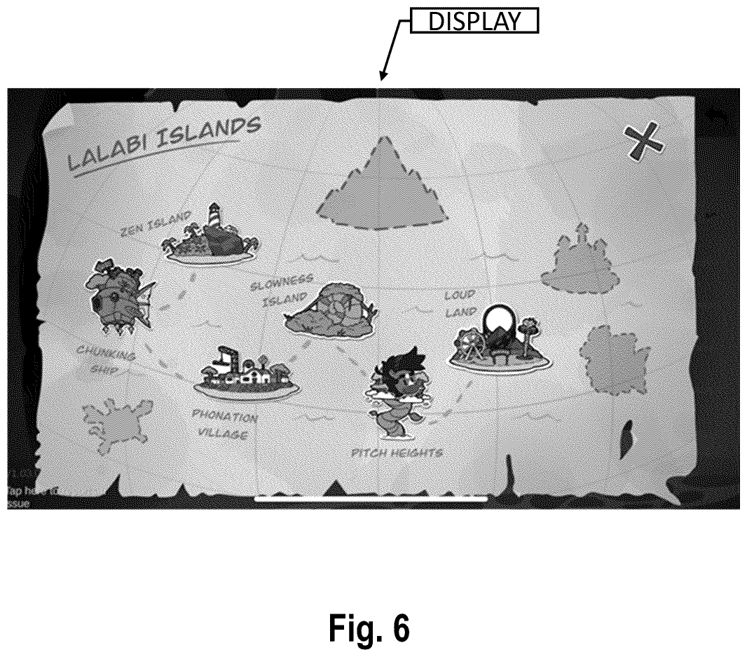

FIGS. 6 through 15 generally illustrates a screen shots of a game embodiment of the invention;

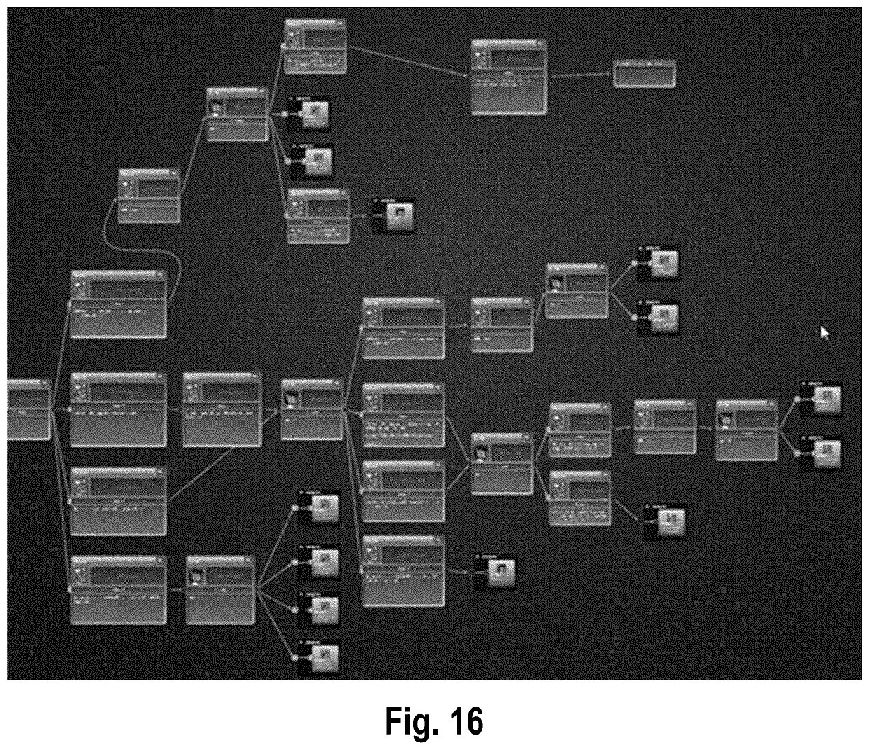

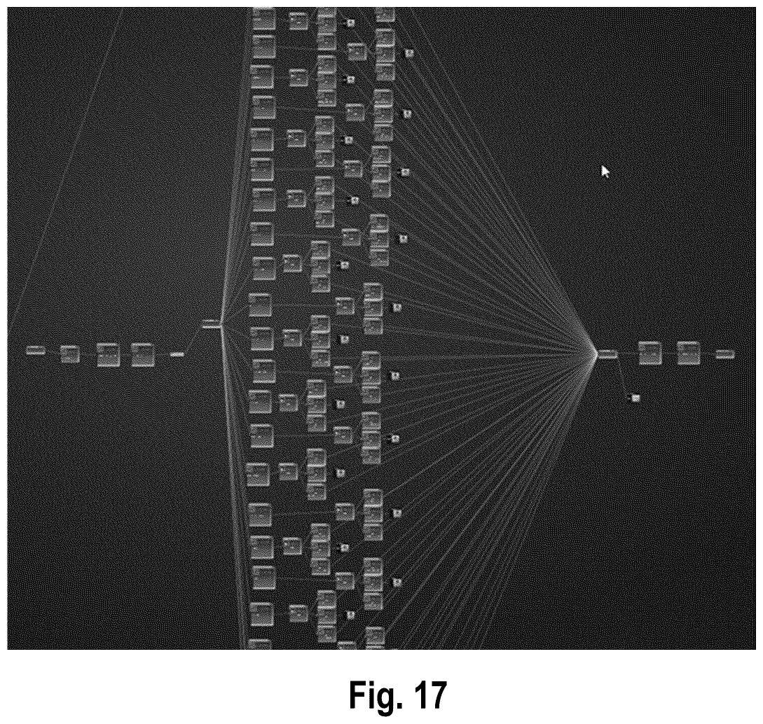

FIGS. 16 and 17 generally illustrate an embodiment of a voice user interface and a respective decision tree; and,

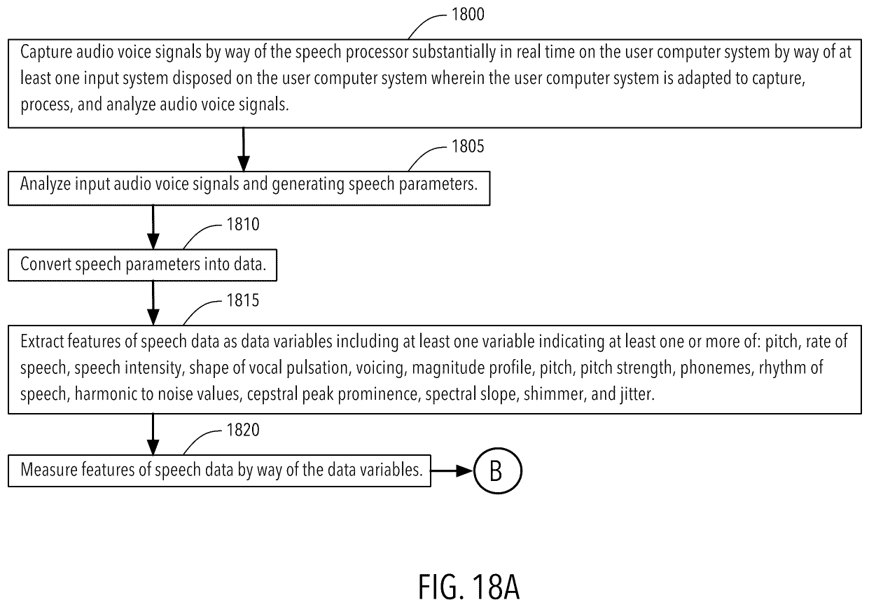

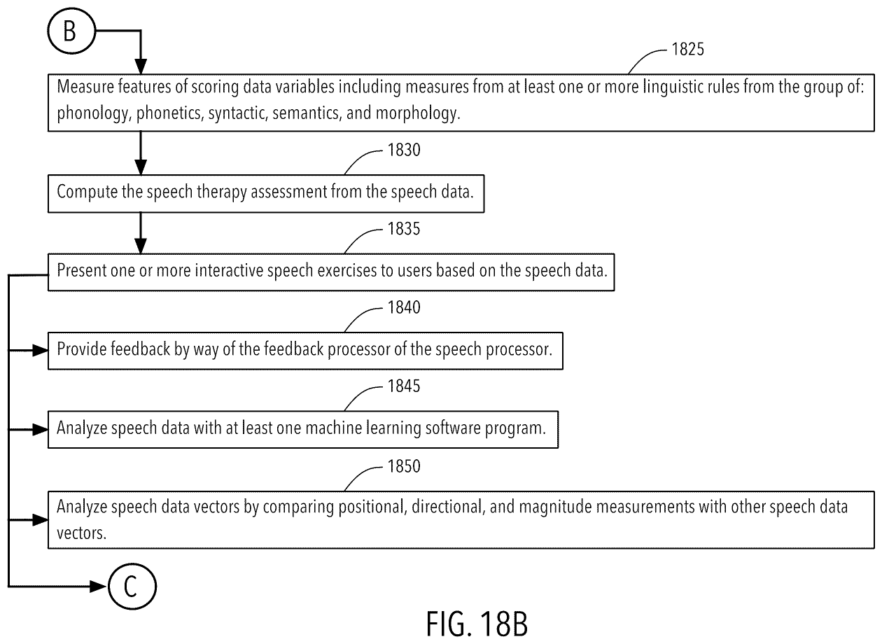

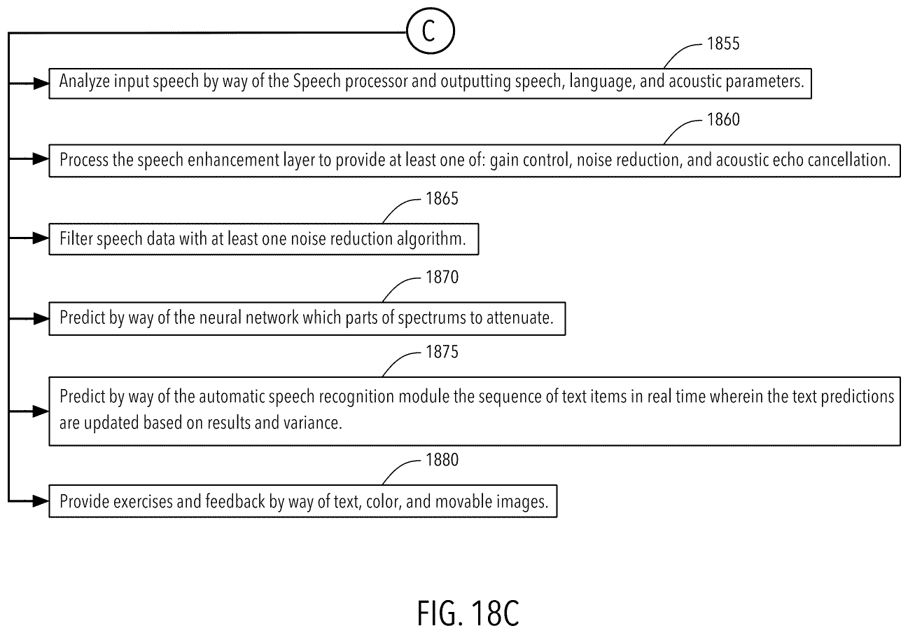

FIGS. 18A-18C generally illustrate a second representative method of the invention for providing speech therapy.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments. As such, those in the art will understand that in any suitable material, now known or hereafter developed, may be used in forming the invention described herein.

It should be noted that the terms “including”, “includes”, “having”, “has”, “contains”, and/or “containing”, should be interpreted as being substantially synonymous with the terms “comprising” and/or “comprises”.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

The invention will refer to the user of the invention, namely the one who benefits the most from using the invention, as the active player.

The active player will use the invention in one or more sessions in order to change the behavior, emotions or thoughts of the active player. Player may also be termed user. A session is a continuous stretch of time in which the active player interacts with the invention. During this interaction, the active player can optionally be assisted by one or more human operators (for example a speech and language pathologist, a parent, a partner or a caregiver). These human operators could for example help with non-speech interaction of the invention or provide an additional explanation of the task that need to be performed while practicing.

Each session consists of one or more tasks that the active player performs. A task refers to a well-defined speech exercise in which the active player is prompted to talk one or more times. In some embodiments of the invention a task could be implemented as a minigame or an adventure quest within a video game. These speech exercises could be novel or be based on existing speech exercises that are used in face to face interaction between a speech therapist and their client.

Each embodiment of the invention contains a list of tasks. Different strategies to select the task for the active player are possible and an embodiment of the invention could implement one or more of these strategies:
selection by the active player
linear progression, meaning a sequence of tasks
adaptive progression: based on a set of predefined rules, the next task is chosen. This next task could be the same task (repetition), or any other task.

The invention is implemented as a software program that runs on a standalone computer or mobile device. The computer or mobile device has one or more internal or external microphones attached, a touch screen or a keyboard and mouse to interact with the invention, a screen to display the user interface of an embodiment of the invention, an optional speaker or speakers to output sound, a hard drive or solid-state drive to store a configuration of the embodiment of the invention and an optional network connection to connect to the internet. In some embodiments of the invention, data that is collected during the use of the invention can be stored remotely on cloud servers. This data can also be stored locally on the device on the hard drive or solid-state drive.

The invention may comprise four main components, namely the speech processor, the feedback processor, the main processor, and the data processor. These processors may be separate physical processors or may be functions combined within one or more physical processors. Each task could result in a different configuration of these components. For example, in an exercise to practice the range of the vocal pitch, the automatic speech recognition module that is part of the speech processor might be disabled.

These components are running locally on the computer or mobile device to increase the responsiveness of the user interface and which could result in a better user experience leading to increased motivation and adherence.

### Speech Processor

The purpose of the speech processor is to analyze the input speech and to generate various speech parameters. These parameters are task-independent. The feedback processor will convert them into the most suitable representation for a particular task.

The purpose of the speech processor is to analyze the input speech and to generate various speech parameters. These parameters are task-independent. The feedback processor will convert them into the most suitable representation for a particular task.

The speech processor has three main internal states:
a loading state, to setup the speech processor configuration. The exact configuration depends on the current task and could optionally depend on the current speech exercise and the current active player. For example, at the loading state, a language model or acoustic model for the automatic speech recognition model could loaded.
a real-time processing state, in which the speech processor actively accepts input from the microphone(s).
an optional final state. In some embodiments of the invention this final state could be triggered by an end-pointer: after the end-pointer is triggered, the automatic speech recognition module could finalize its speech recognition hypothesis.

First, the output of the microphone(s) is converted into the representation required by the speech processor, for example 16 bit integer or 32 bit float mono signal sampled 16000 Hz or 48000 Hz. Multi-channel signals could be converted into a mono channel by averaging all channels or by using applying techniques such as beam-forming (Lashi et al. 2018).

Next, well-known speech enhancement algorithms such as automatic gain control (Tisserand and Berviller, 2016), noise reduction (Valin 2018), or acoustic echo cancellation (Zhang et al. 2022) could be applied to input speech signal to improve the signal-to-noise ratio or to boost the signal.

Next, the speech processor could produce three main types of measurements:
Global measurements. Examples of such measurements are age and gender estimation from speech, speaker recognition and speaker diarization, and emotion recognition from speech. These measurements have in common that they will produce a single (non-temporal) output based on the available speech input. The output of these measurements could be further used in other modules of the speech processor. For example, based on the estimated age and gender, different parameters of the pitch module could be used.
Realtime, text-independent measurements. These provide new measurements at a constant rate, for example at 100 Hz. Examples of such measurements are pitch (Talkin 1995), loudness, average magnitude profile (Awad 1997), phonological posteriors (Vásquez-Correa et al. 2019), voice activity detection (Dekens & Verhelst 2011), breathing detection, articulatory variability detection or text-independent disfluency detection (Lea et al. 2021).

The breathing detection can be implemented by filtering the input signal. The loudness of the filtered signal will then indicate how much breathing is present in the speech signal. Pitch measurements can also be used to remove the influence of voiced speech segments. This filtering step could be implemented by a common frequency domain filter. In some embodiments of the invention, this filtering step could be implemented similar to how noise is reduced in modern noise reduction algorithms such as in (Valin 2018): the signal is filtered in the frequency domain using a deep neural network that predicts which parts of the spectrum to attenuate. To train this deep neural network, the invention uses a database that contains labeled breathing sounds and non-breathing sounds.

The articulatory variability detection estimates how much the articulators move at a certain position in time. The most accurate way to do this is to attach markers at the speech production organs and to measure their movements using cameras or electromagnetic articulography. The local variability in speech can be a proxy to estimate the articulatory variability. A huge advantage is that the invention does not need to rely on specialized equipment and that the measurement can be done unobtrusively using the microphone(s). This variability is estimated as follows. First, calculate Mel frequency cepstral coefficients (MFCCs) (e.g. 13 MFCCs) for overlapping frames in the signal. The overlap should be high in order to capture small changes. For example, 40 ms frames with a hop-size of 1 ms can be used. The acoustic variability can be estimated by looking at the delta MFCC features. However, this will overestimate the variability of the articulators. The invention will therefore take the weighted sum (e.g. using a triangular weighting function) of the L2 norms of the delta MFCC vectors around the current position (for example 20 frames on the left and right could be taken into account).
Text-dependent measurements. These measurements depend on detecting the text information that is present in the speech signal. The input signal is therefore first converted into text. This is done by one or more automatic speech recognition (ASR) modules. An ASR module predicts a sequence of so-called text items. This can be done in a streaming, real-time fashion where the text predictions are regularly updated, or in a non-streaming scenario. A common representation of such text item is a word, a word piece (a sequence of letters that represent a word or part of a word) or a character (for example for Mandarin Chinese). Internally, these text items are commonly represented as a sequence of base units, such as letters or phonemes). An ASR module could also output (an estimation of) the timings and the durations of the base units or text items. In some embodiments of the invention, the timing information can also be combined with the real-time measurements, such as pitch and loudness, to estimate prosodic properties of the speech such as pitch accents or stress patterns (Rosenberg 2010).

Embodiments of the invention take the weighted sum (e.g. using a triangular weighting function) of L2 norms of delta Mel Frequency Cepstral Coefficient (MFCC) vectors around the current position (for example 20 frames on the left and right can be taken into account). The L2 norms of the delta MFCC vectors can be calculated as follows:
Let M_i=[m_i_1,m_i_2, . . . , m_i_num_mfccs] and be an array that represents the i-th MFCC vector. This is the MFCC vector of the i-th frame of the input speech signal.

The delta MFCC vector DeltaM_i can be calculated as:

$$DeltaM\_i = M\_ ( i - 1 ) + M\_ ( i + 1 ) .$$

Other delta functions can also be used. The L2 norm of a vector is the root of the sum of the squared elements of this vector. Comparisons may be made to improve speech performance that may further include, but not be limited to, using such vector-based measures as cosine similarity between vectors and Pearson correlation coefficients.

### Main Processor

The role of the main processor is to present for each task, one or more interactive speech exercises for the active player using the attached screen(s), input devices such microphone(s), keyboard, mouse or touch input, and loudspeaker(s) or headphones. In addition to the output of the feedback processor, the main processor could also directly use the output of the speech processor to create an interaction with the active player.

Examples of interactions:
Realtime synchronization of text and speech
Base units
Speech items (word pieces)
Character groups
Scaffolding
Motivational techniques

### Data Processor

The data processor is optional and stores the data that was generated in the other modules in a session. The exact type of data that is stored depends on the embodiments of the invention.

This data could be used in the invention in four ways:
a) for improvement of the speech processor
b) for improvement of the feedback processor and
c) as part of the behavioral loop in the game processor and
d) to inform the active player or human operators about the current and past states of the active player as measured by the collected data.

While it is common to improve devices and software applications that make use of machine learning algorithms by retraining the machine learning algorithms using new or updated data sets, the same algorithms will be used for all users of those devices or applications. These machine learning algorithms could consist of but are not limited to deep neural networks, decision trees, support vector machines, rule-based, and related approaches.

It is well-known in the field of machine learning that if one has enough data, it is possible to generate personalized machine-learning models, that are optimized for a particular user of a device or software application. There are four main problems that hinder the deployment and training of these personalized models in practice: a) a lack of reliable training data of that particular user, b) a lack of resources to train these personalized models at scale for all users, c) a lack of resources to manage and distribute these personalized models and d) the issue that multiple users could share the same device.

To deal with these shortcomings, the invention includes optional personalized learning modules for the speech or the feedback processor. This module allows the user, or back-end user, to use personalized settings of the device and train these personalized settings on-device. It works as follows:
Initially, the default, non-personalized settings are being when the invention is used. Data relevant to 1 or more parts of the speech or the feedback processor are stored on-device. The storage could be encrypted or happen in a specialized database or other storage structure on the hard drive or solid state disc of the computer or mobile device.
The quality of the relevant data is rated automatically using a machine learning algorithm on the device. Optionally, the relevant data could also be rated using an external cloud service.
When the invention is in use, there are moments between tasks when the active player is not actively engaging in a speech exercise. Examples of such activities are: looking at a menu screen before selecting an option or looking at a results screen that displays progress. At these times, the computer or mobile device might be using less computational resources. This means the invention can use some of the computational resources for training personalized models. The invention can determine the best times for this training on predetermined rules or by looking at how much power is currently consumed by the computer or mobile device. The training is not limited to one session, but could span multiple sessions. In the latter case, the training state is saved and restored at the start of the next session.
To avoid excessive training time on consumer devices with limited computational resources, adaptation or fine-tuning techniques are contemplated, which techniques result in rapid training. Examples of such techniques are fine-tuning by freezing part of the deep neural network layers, Adapters (Hou et al. 2021) or Prompt-tuning (Dingliwal et al. 2021). After training on the device itself, the personalized model does not need to be distributed as it is already present on the user's computer or mobile device.
Multiple users could share the same device. The invention solves this in two ways. In some embodiments of the invention, the invention uses an authentication module that introduces an authentication step when using the invention: different profiles are created for different users. Another solution would be to use Speaker Recognition (Homayoon 2011) to determine which user is using the invention.

### Speech, Language, and Cognitive Therapy

The speech therapy content is downloaded onto the device from the internet. The content includes tens of thousands of unique utterances that are organized according to linguistic rules including phonology, phonetics, syntactic, semantic, and morphology and therapy techniques. The therapy techniques focus on speech, language, cognitive therapy. All therapy uses evidence-based research based on the practice portal (See https://www.asha.org/practice-portal/) organized by the American Speech and Hearing Association.

Therapy techniques are taught in our games using scaffolding. Scaffolding is based on incremental learning. Incremental learning implies that just enough information is provided to ensure the player has early success in producing the target therapy. The goal of scaffolding to for the player to practice frequently and independently. Regardless of the therapy being taught, a digital speech therapist is built into the software using human to computer interactions (hereinafter “HCI”).

The HCI are presented as therapy concepts to a player using best practices in voice-user-interface (hereinafter “VUI”) design. The VUI is presented as a visual process or auditory process or a combination of the two, where the player is taught a concept of speech therapy in order to complete a task. When a new lesson is presented, the VUI always starts by presenting the concept. What follows next is the VUI demonstrating an example of the concept, followed by offering the player to practice the concept, ending with a decision state to either continue scaffolding or continue in the game. The decision logic is based on the success of the player. If a player is immediately successful at passing the target concept, the system will allow the player to continue more quickly into the game. Feedback is provided by the VUI system on two instances. In the first instance, while the player is successfully saying the target correctly using the correct input style, encouragements are given either visually or auditorily, or both. In the second instance, when the player does not utter the target using the correct therapy technique or techniques, specific feedback from the system to the player will be given. This feedback will be specific and relevant to the target exercise.

Phonological processes are taught by the software and offer thousands of unique practice opportunities. The software teaches all common techniques seen in therapy for speech sound disorders including but are not limited to backing, fronting, substitution, simplification, deletions, and other common phonological patterns. The treatment also includes phonetic processes and often referred to as bombardment by speech and language pathologists. This is where the player is asked to produce one or more given sounds in rapid succession.

Language disorders are taught by the software. Players are supported when they struggle with difficulties with syntax, semantics, and morphological processes. Therapy taught by the software includes, but is not exhaustive to word retrieval, working and short-term memory system exercises such as recalling sentences, grammar, naming, sentence comprehension, word classes, understanding spoken paragraphs.

The speech therapy software teaches how to produce sounds more naturally according to the science of suprasegmentals of speech also known as prosody. Prosodic elements of speech support effective communication and natural sounding manner of conveying messages from one interlocutor to another. The prosodic elements include speech rate, amplitude, pitch, stress, and pausing.

The speech therapy software teaches Cognitive exercises. These are specific to the neurocircuitry within the frontal lobe and target areas of the brain involved in executive function. The software teaches players to work on planning, flexible thinking, time management, self-monitoring, inhibition, and practicing working memory system and short-term memory system.

The speech therapy software teaches mindfulness. Mindfulness games include breathing exercises and sustained phonation. Neurologically seen, as the amygdala shrinks, the pre-frontal cortex—associated with higher order brain functions such as awareness, concentration and decision-making—becomes thicker.

The “functional connectivity” between these regions, i.e., how often they are activated together, also changes. The connection between the amygdala and the rest of the brain gets weaker, while the connections between areas associated with attention and concentration get stronger. It is the disconnection of our mind from its “stress center” that seems to give rise to a range of physical as well as mental health benefits.

When a person is feeling extra stressed, the emotional center for the brain, known as the amygdala, takes over the parts of the brain associated with higher brain functions such as concentration, decision-making, or awareness, all found in the frontal cortex.

Mindfulness exercises, such as breathing or phonation tasks, have shown to diminish the activity in the amygdala and activate activity into the frontal cortex. Over time, the connections between the amygdala and front cortex will get weaker, while the connections in the associated regions of the frontal cortex will get stronger. This means the fight or flight ‘stress center’ becomes less important. When this happens, individuals start feeling both physically and mentally healthier.

Practicing mindfulness exercises can lead to positive permanent changes in the ‘functional connectivity’ of the brain, helping individuals achieve much higher levels of attention and concentration in our daily lives.

### Neuroscience

The games (i.e., the invention) foundationally incorporate evidence-based research. The game for stuttering includes exercises based on what happens neurologically when people stutter. Stuttering is a neurological disorder that affects speech initiation, timing, rhythm, and naturalness. Stuttering can also worsen symptoms of stress and anxiety. All games focus on the precise neuro-circuitry or brain region being addressed. Cognitive exercises focus on the frontal cortex, language exercises involving understanding will access Wernicke's area, and exercises focusing on word retrieval focus primarily on Broca's area.

During the stuttering game, the focus is on the neurocircuitry of the cortical-basal ganglia-thalamocortical loop (hereinafter “CBGT-loop”) as it has been shown to be the primary area involved in speech fluency. During phonological and articulation disorders, therapy focuses on neurocircuitry targeting Broca's area, and specifically the region around the posterior inferior frontal gyrus, the primary area involved in the movement required for the production of speech. For language comprehension tasks, exercises targeting the posterior superior temporal gyrus, specifically the area known as Wernicke's area are addressed. Both expressive and receptive speech disorders are addressed when focusing on both Broca's and Wernicke's area. The Angular gyrus is a part of the brain focusing on the reading abilities involved in comprehension. The Superior temporal gyrus, also known as the “Heschyl's gyrus”, is involved in auditory processing, and the primary visual area, both of which are addressed when focusing on therapy for dyslexia and the interpretation of speech sounds.

Adverting now to the figures. As shown in FIG. 1, within mobile device 102, a plurality of computation modules receives the speaker's raw audio by way of the microphones and perform source separation, noise removal, end-point detection, automated measurements, automated assessment and record the speaker's voice on mobile device 102 (platform). A plurality of second computation modules store the audio data and process that data to the device in real-time. A plurality of third computation modules on device provide training and practice capabilities for users (e.g., persons in need) to practice various therapy techniques on mobile device 102. A plurality of fourth computation modules also on the device provide the speech language pathologist with capabilities to view data, e-mail data, and both receive and provide speech therapy feedback. A plurality of fifth computation modules on device separately, or in combination with server 102, processes audio data for measurements, assessment, storage and client profile management.

FIG. 2 depicts an exemplary embodiment of mobile device 102. It can comprise wired and/or wireless transceiver 202, user interface (“UI”) display 204, memory system 206, location unit 208, and processor 206 for managing operations thereof. Mobile device 102 can be a cell phone, a laptop, a desktop, a notebook, a tablet, or any other type of portable and mobile communication device. Power supply 212 provides energy for electronic components. Mobile device 102 also includes microphone 216 for capturing voice signals and environmental sounds and speaker 218 for playing audio or other sound media. One or more microphones may be present for enhanced noise suppression such as adaptive beam canceling, and one or more speakers 218 may be present for stereophonic sound reproduction. Some special chips are available on some devices might contain additional chips 210 to speed up neural network calculations.

Briefly, the exemplary embodiments provide a novel approach for providing clinical therapy in real-life situations. Specifically, the audio separation can be performed on the user's voice signal as a function of user's speech patterns and knowledge of psychoacoustics as a means of separating out articulatory gestures affecting a speech disorder. Using this further information, conventional issues can be bypassed allowing measurements to be carried out from real-life audio data. Conventional noise cancellation techniques also include other issues when noise data is mistaken for speech data and the conversion results in a bad audio stream. The use of a user's speech pattern and novel psychoacoustics avoid these issues altogether.

During this time, noise reduction techniques or background estimate techniques can be applied to acquire other signal parameter estimates, used in view of the user's voice, to assess voicing efforts, disorders and pronunciation styles. As one example, mobile device 102 estimates noise signal and vocal pattern statistics within the captured voice signal and suppresses the noise signals according to a mapping there between. In one embodiment, this may be based on a machine learning of the spatio-temporal speech patterns of the psychoacoustic models. The machine learning may be further implemented or supported on the device by way of pattern recognition systems, including but not limited to, Digital signal processing and Neural Networks, Hidden Markov Models, and Gaussian Mixture Models.

FIGS. 1, 2, and 3, therefore, illustrate overall a speech recognition technology system for delivering speech therapy that has at least one the processor system, at least one the memory system, and at least one the user interface disposed on at least one the user computer system, the user computer system designed to be operationally coupled to at least one server computer system 130. At least one input system is disposed on the user computer system designed to, substantially in real time, capture, process, and analyze audio voice signals. A processor system is disposed on at least one or more of user computer system 100, which may also be mobile device 102, and the server computer system 101, a processor system 114 operating as at least one or more of speech processor 112 designed to analyze input audio voice signals and generate speech parameters, feedback processor 110 designed to convert measurements generated by speech processor 112 into speech data, the processor designed to present one or more interactive speech exercises to users based on the speech data, and the memory 206 designed to store the speech data. At least one software program 115 is disposed on the at least one or more of the user computer system 100 and server computer system 101, software program 115 including at least one machine learning algorithm designed to receive speech data from the processor, the machine learning algorithm designed to provide users with reports 500, reports 500 designed to provide at least one score 510 through which to aid users at improving speaking performance. Score 510 includes at least one variable indicating at least one or more of: pitch, rate of speech, speech intensity, shape of vocal pulsation, voicing, magnitude profile, pitch, pitch strength, phonemes, rhythm of speech, harmonic to noise values, cepstral peak prominence, spectral slope, shimmer, and jitter. Score 510 assessments include Measures 505 from at least one or more linguistic rules from a group of: phonology, phonetics, syntactic, semantics, and morphology.

In some embodiments of the speech recognition technology system for delivering speech therapy, the speech data includes at least one vector having positional, directional, and magnitude measurements. In some embodiments of the speech recognition technology system for delivering speech therapy, the speech data includes delta Mel Frequency Cepstral Coefficient (MFCC) vectors. In some embodiments of the speech recognition technology system for delivering speech therapy, user computer system 100 and server computer system 101 are designed to operate as an edge computing system, further having at least one edge node and at least one edge data center.

In some embodiments of the speech recognition technology system for delivering speech therapy, further including speech processor 112 arranged to analyze input speech and to output various speech and language parameters, including a processor, the processor arranged with an automatic speech recognition model, the automatic speech recognition model to be loaded with at least one of: a language model and an acoustic model. In some embodiments of the speech recognition technology system for delivering speech therapy, along with a microphone in communication with the processor, wherein the microphone is arranged to collect audio inputs and output the audio inputs to the processor in sequences.

Some embodiments of the speech recognition technology system for delivering speech therapy have a plurality of processing layers, each of the plurality of processing layers having at least one processing module. In some embodiments of the speech recognition technology system for delivering speech therapy, one of the plurality of processing layers includes a converting layer arranged to convert the output of the microphone into a representation accepted by the processor system 114. In some embodiments of the speech recognition technology system for delivering speech therapy, one of the plurality of processing layers includes: a speech enhancement layer including an algorithm arranged to provide at least one of: automatic gain control, noise reduction, and, acoustic echo cancellation.

In some embodiments of the speech recognition technology system for delivering speech therapy, at least one noise reduction algorithm is designed to filter speech data. Some embodiments of the speech recognition technology system for delivering speech therapy further use a neural network designed to predict which parts of spectrums to attenuate. In some embodiments of the speech recognition technology system for delivering speech therapy, an automatic speech recognition module is designed to predict a sequence of text items in real time wherein the text predictions are updated based on results and variance from predictions. In some embodiments, the user interface is designed to provide feedback by way of text, color, and movable images, which themselves may present games wherein users/players may compete against a standard, themselves, or other people.

Referring to FIG. 4, a method for speech therapy utilizing the invention is generally shown. Method 400 can start in a state where a user is operating mobile device 102. At step 402 a voice signal is captured on the mobile device. This can be achieved by way of the microphones which in one embodiment digitally sample analog voice signals. At step 404, the mobile device by way of the processor extracts speech features from the voice signal. The speech features include speaking rate, voicing, magnitude profile, intensity and loudness, pitch, pitch strength, and phonemes.

Upon speech feature extraction 404, as shown at step 406, the processor 114 performs an automated measurement of the extracted speech features on mobile device 102, step 407. The automated assessment includes measuring changes in roughness, loudness, overall severity, pitch, speaking rate, spectral analysis for voicing, and statistical modeling for determining pronunciation, accent, articulation, breathiness, strain, and applying speech correction. The measurement can include calculation of harmonic to noise values (hereinafter “HNR”), cepstral peak prominence (hereinafter “CPP”), spectral slope, shimmer and jitter, short-and long-term loudness, and harmonic determinations. The automated measurements comprise stop-gaps, repetitions, prolongations, onsets, and mean-duration.

As shown in step 410, the edge device computes the speech input from the measurement of data and corresponding speech received. The evaluation of the target speech is made in from the device's own processing of the voice signal. Edge devices can further perform the steps of mapping the speech features and voice signal to particular registered users, associating the speech signal to a user voice profile of a registered user, collecting objective user feedback associated with the delivery of the speech therapy technique, and adapting the speech therapy technique in accordance with objective user feedback corresponding to the user voice profile.

At step 416, the mobile device provides direct speech therapy, which can include voice correction, pronunciation guidance, and speaking practice, but is not limited to these. The signal processing techniques that implement the speech therapy technique include a combinational approach of psychoacoustic analysis and processing performed on mobile device 102 directly.

The GUI by way of mobile device 102 provides for speech compensation training on mobile device 102 in accordance with the speech therapy technique shown in step 420 on FIG. 4. Notably, as shown in step 422, during the delivery of the speech therapy technique and training in real-time or through scheduled intervention monitors, users can manage and modify the speech therapy technique through feedback provided by the automatic generation of Reports 500. This can include scheduled intervention or one-on-one dialogs between the user and provider in real-time during a speech therapy session or requested user intervention.

As part of the speech therapy and compensation training, and as previously discussed and shown in FIG. 3, the user may be presented with a speech therapy GUI that provides the user with training. The GUI can provide speech feature correction to the voice signal (or propose alternative pronunciations), display the speech therapy result, and provide for speech compensation training on the mobile device in accordance with the speech therapy technique. Notably, the training experience is stored both on device and on the server to provide clinical feedback and outcome modeling. This information along with the speech therapy can be stored with the user's voice profile for continued evaluation and retrieval. As one example, mobile device 102 amplifies and attenuates voiced sections of speech for fluency shaping, shortens detected silence sections to enhance speech continuity, overlap and adds repeated speech sections to correct stuttering, and adjusts a temporal component of speech onsets to enhance articulation.

The GUI delivers the speech therapy technique and training to employ corrective actions associated with these communication disorders. The GUI provides initial training of a given technique on the device where the user is offered incremental practice with system-user interactions. Upon successful measurements, the GUI offers speech therapy targets, followed by the system's real-time and relevant feedback provide on the device. This process continued until the system receives a minimal number of successful measurements.

The Unity game development platform using C# as scripting language 300 and the native IL2CPP Unity backend 302 are imported onto the device including the localized test, voice overs for a video game, and speech therapy content 304. The functionality of Unity is extended further by creating two native unity plugins and integrating them in the game. “Speech plugin” 306 contains all the speech technology that is needed in game 307. “Backend plugin” 308 stores user progress, user credentials, game analytics, and extra information for debugging on local device 310, and it is able to synchronize this data with remote server 312. These plugins are portable across different platforms and can be used on mobile device 102.

The remote backend of the pre-prototype is complementary to the game. It is developed, in representative embodiments, as a C++ application and shares code with the backend plugin. This application runs on secured Linux server 314. PlayFab 316 and Unity Analytics 318 are further used to store additional game analytics. Collecting a large amount of data on how the game is played enables us to use data for learning analytics (to optimize learning) of the game. In the event that an internet connection is not available, the game is still fully functional so long that user credentials are valid. Game analytics and progress will be synchronized once internet access is restored.

Adverting now to FIG. 5. The following description should be taken in view of the aforementioned figures and respective descriptions. The purpose of the speech processor 112 is to analyze the input speech and to output various speech and language parameters. These parameters can take the form of a scalar value, sequential data in the form of a numeric array or discrete categorical data. These parameters are task-independent. Feedback processor 110 will convert them into the most suitable representation for a particular task and could perform additional operations on these.

Speech processor 112 has three main internal states:
a) a loading state, to setup the speech processor 112 configuration. The exact configuration depends on the current task, and could optionally depend on the current speech exercise and the current active player. For example, at the loading state, a language model or acoustic model for the automatic speech recognition model could be loaded.
b) a real-time processing state, in which speech processor 112 actively accepts input from the microphone(s). The microphone(s) will send short sequences (chunks) of sampled audio data to speech processor 112. Speech processor 112 will then process each sequence after each other.
c) an optional final state. In some embodiments of the invention this final state could be triggered by an end-pointer. An end-pointer is the duration of a silence after speech was detected. After the end-pointer is triggered, the automatic speech recognition module could finalize its speech recognition hypothesis.

Speech processor 112 consists of several processing layers (see figure). In each layer, processing modules 135 are present. These modules could access the output of processing modules 135 of all the previous layers. Each processing module 135 outputs one or more scalar values, sequential data in the form of a numeric array or discrete categorical data.

First (layer 0), the output of the microphone(s) is converted into the representation required by the Speech processor 112, for example 16 bit integer or 32 bit float mono signal sampled 16000 Hz or 48000 Hz. Multi-channel signals could be converted into a mono channel by averaging all channels or by using applying techniques such as beam-forming (see for example (Lashi et al. 2018)). This results in an array x_i, with i=1:num and num the number of values in the input array divided by the number of input channels. This array x_i represents one input speech chunk. In the real-time processing state of speech processor 112, the invention storing all input speech chunks in large array (the input buffer) in memory system 206 until speech processor 112 is in a final state or until the number of stored speech samples exceeds the length of the buffer.

Next (layer 1), speech enhancement algorithms such as automatic gain control (see for example (Tisserand and Berviller, 2016)), noise reduction (see for example (Valin 2018)) or acoustic echo cancellation (see for example (Zhang et al. 2022)) could be applied to each input speech signal chunk. These algorithms are commonly used in applications where speech is processed to improve the signal-to-noise ratio or to boost the signal. The output of this layer is a mono-channel clean signal that is stored in a large array (the clean input buffer) in memory system 206. Newly processed output signals are appended to the end of this buffer until speech processor 112 is in a final state or until the number of stored speech samples exceed the length of this buffer.

The next layer (layer 2) contains speech processing modules that calculate two types of measurements, namely global measurements and real-time, text-independent measurements.

Global measurements predict the state of the active player from speech, or estimate properties of the active player from speech. Examples of such measurements are age and gender estimation from speech, emotion recognition and speaker recognition. These measurements will typically output one or more scalar values or discrete categories. For example, to estimate the age range of the active player, the invention can use a multi-layer perceptron model (Ravishankar et al. 2020). Based on data x_i in the clean input buffer (with i=1:length_clean_input_buffer), the invention can calculate a sequence of acoustic features such as Mel Frequency Cepstral Coefficients (MFCCs). These features can then be used as input for a multi-layer perceptron model or another machine learning classifier. The global measurement output values could be further used in other modules of speech processor 112. For example, based on the estimated age and gender, different parameters of the pitch module could be used.

The speech processing module generates real-time, text-independent measurements on 1 or more sequences of output data. Each sequence represents temporal data, measured at a constant rate, for example at 100 Hz. Examples of such measurements are pitch (see for example (Talkin 1995)), loudness (see for example (Benesty et al. 2008), average magnitude profile (Awad 1997), phonological posteriors (Vásquez-Correa et al. 2019), voice activity detection (Dekens & Verhelst 2011), breathing detection (See below), articulatory variability detection (see below) or text-independent disfluency detection (Lea et al. 2021).

The breathing detection can be implemented by first filtering the input signal and then calculating loudness values for each frame of this filtered signal. These loudness values will then indicate how much breathing is present in the speech signal. As a very simple proxy for perceptual loudness the invention can use the maximum amplitude of the i-th frame of the speech signal:
maxamp_i=max(abs(x_j)), j=i*hop_size+1:i*hop_size+frame_size

Here hop_size is the duration in samples between each frame and frame_size is the length of a frame in samples. Pitch measurements can also be used to remove the influence of voiced speech segments by settings the breathing detection output to 0 if pitch is detected in the last N frames. This filtering step could be implemented by a digital filter y=h_breathing(x) with x the input signal, y the output signal and h_breathing the filter function. For example, this digital filter could be an infinite impulse response (hereinafter “IIR”) or finite impulse response (hereinafter “FIR”) filter.

In some embodiments of the invention, this filtering step could be implemented similar to how noise is reduced in modern noise reduction algorithms such as in (Valin 2018): the signal is filtered in the frequency domain using a deep neural network that predicts which parts of the spectrum to attenuate. To train this deep neural network, the invention needs to use a large database that contains labeled breathing sounds and non-breathing sounds.

The articulatory variability detection estimates how much the articulators move at a certain position in time. The most accurate way to do would be to attach markers at the speech production organs and to measure their movements using camera's or electromagnetic articulography. Local variability in speech can be a proxy to estimate the articulatory variability. A huge advantage is that the invention does not need to rely on specialized equipment and that the measurement can be done unobtrusively using the microphone(s). This variability is estimated as follows. First, calculate mel frequency cepstral coefficients (hereinafter “MFCCs”) (e.g. the first 13 MFCCs) for overlapping frames in the signal. The overlap should be high in order to capture small changes. For example, 40 ms frames with a hop-size of 1 ms could be used. The acoustic variability can be estimated by looking at the delta MFCC features. However, this will overestimate the variability of the articulators, as they typically move relatively slow. Taken is the weighted sum (e.g. using a triangular weighting function) of the L2 norms of the delta MFCC vectors around the current position (for example 20 frames on the left and right can be considered).

Next part of speech processor 112 is the ASR layer (layer 3), which contains 1 or more automatic speech recognition (hereinafter “ASR”) modules. Examples of ASR module are: HMM-based speech recognition, end-to-end speech recognition using neural networks, conformed-based speech recognition or RNN-T-based speech recognition. Multiple of these ASR modules can be used simultaneously. This can be advantageous in some applications, as some ASR modules could for example be optimized for streaming (real-time) speech to text, while other ASR modules might be optimized for the highest accuracy but do not run in a streaming fashion. The output of multiple ASR modules could be combined to increase the accuracy of the speech to text prediction.

The output of this ASR layer is the segmentation of the speech signal (speech segmentation). This segmentation is created as follows; Each ASR module predicts a sequence of so-called text items. This can be done in a streaming, real-time fashion where the text predictions are regularly updated, or in a non-streaming scenario. A common representation of such text item is a word, a word piece (a sequence of letters that represent a word or part of a word) or a character (for example for Mandarin Chinese). Internally, these text items are commonly represented as a sequence of base units, such as letters or phonemes. An ASR module could also output (an estimation of) the timings and the durations of the base units or text items. These timings result in the segmentation of the speech signal.

The modules of the final layer (i.e., Classification/Regression, or layer 4) of speech processor 112 use the speech segmentation and types of data that is outputted by the previous processing layers for classification or regression. This can be used for example to estimate prosodic properties of the input speech signal such as pitch accents or stress patterns (Rosenberg 2010).

The following description should be taken in view of the aforementioned description, figures, and FIGS. 6 through 15, which generally illustrate screenshots of a display which is showing a game embodiment of the invention. Such screens may be used outside a game embodiment, but game environments allow users/players to compete against standards, themselves, and others. This illustration is a representative illustration.

FIG. 6 generally shows a map of the game embodiment of the invention, which figure generally illustrates islands as ‘unlocked’ since they are all colored, i.e., showing details, whereas a locked island of the game, only displays an outline and/or is grey.

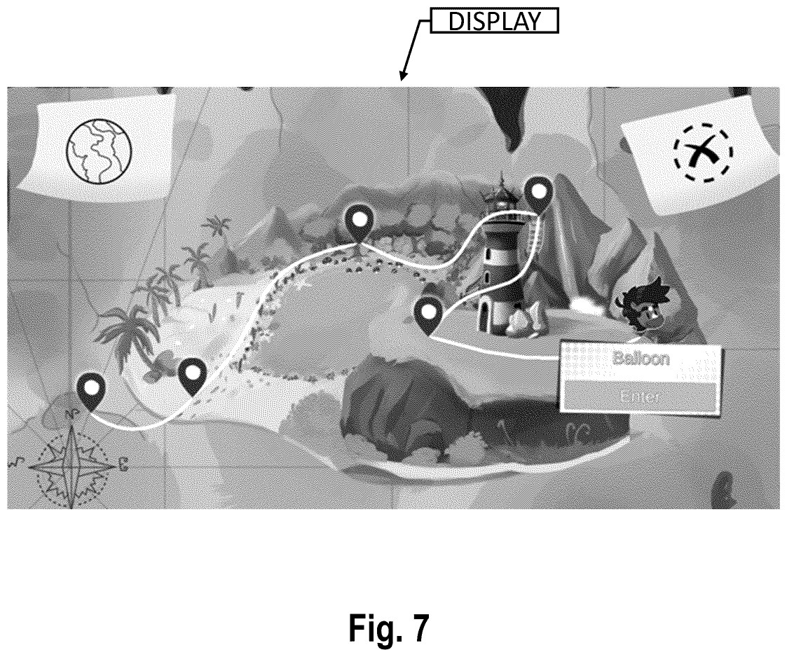

FIG. 7 generally shows a map of a specific island shown in FIG. 6, i.e., a specific island map. Each node (typically indicated in red, or other color) reflects a mini-game where a user practices and/or practiced, a specific skill. Each of the islands, shown in FIG. 6, generally reflect exactly one therapy skill, however multiple algorithms are active on each island—in other words and alternatively, multiple skills could also be stage on each specific island. In a preferred embodiment, each island uses noise reduction, acoustic echo cancellation, and automatic speech recognition and automatic speech alignment algorithms.

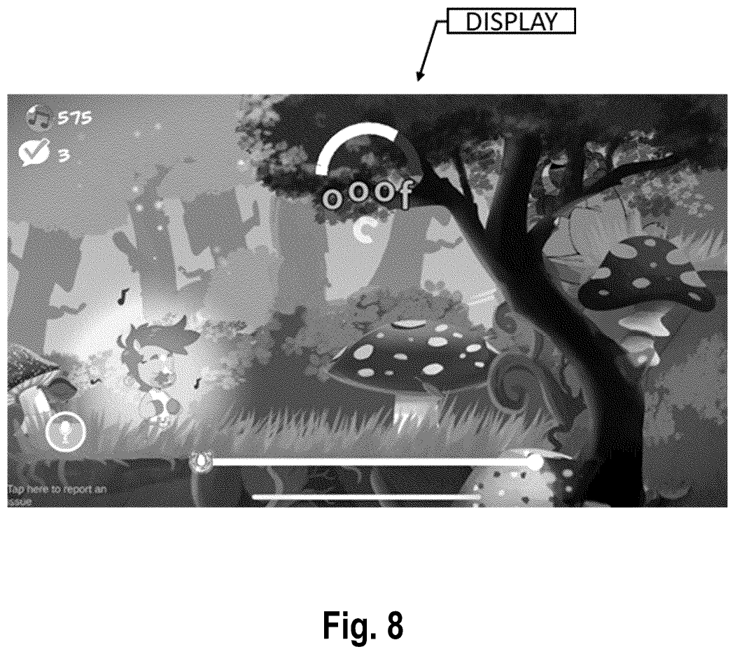

FIG. 8 generally illustrates a scene from a first island, or island 1, which generally shows a scene from a mushroom climb (a designed stage for the game and/or skill associated with island 1) where the user practices engaging their vocal cords with voiced non-plosive sounds (into the microphone). In some embodiments, island 1 may include at least one (or a combination thereof, or all) of the following active algorithms: ASR for wrong word, voice activity detection, wrong pronunciation, too fast pronunciation, disfluency detection (block, word repetition, and prolongation), unvoiced sound.

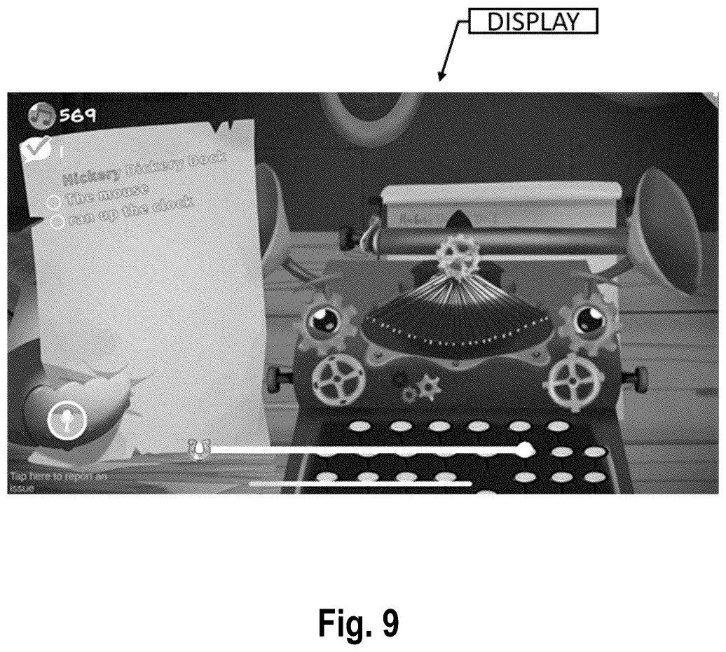

FIG. 9 generally illustrates a scene from a second island, or island 2, which generally shows a scene from a typewriter (a designed stage for the game and/or skill associated with island 2) where the user practices phrasings (i.e., word phrasing) and pausing. In some embodiments, island 2 may include at least one (or a combination thereof, or all) of the following active algorithms: ASR for wrong word, wrong pronunciation, voice activity detection, too fast, disfluency detection (block, word repetition, and prolongation), unvoiced sound, pause detection (waiting too long, not waiting long enough, pausing at the wrong part of the phrase, pausing between words).

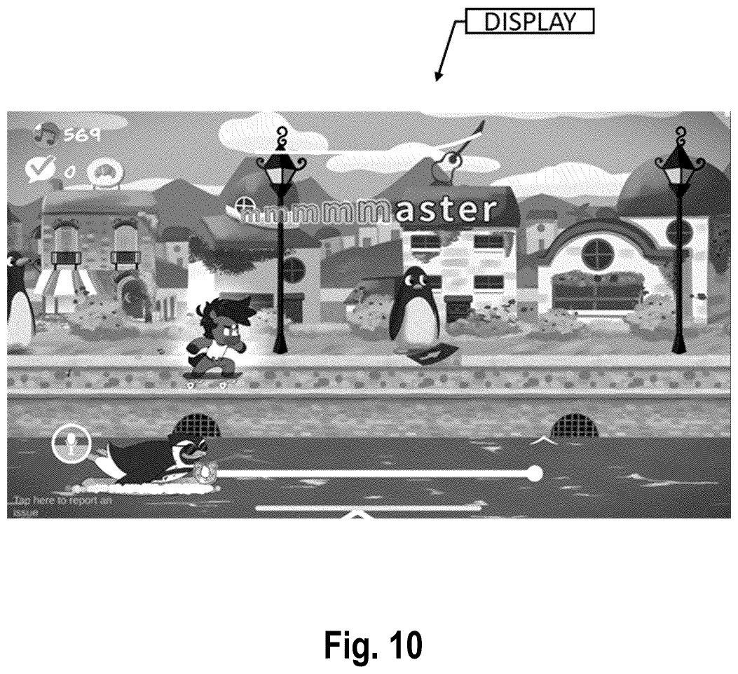

FIG. 10 generally illustrates a scene from a third island, or island 3, which generally is arranged for Easy Onset and Light Contrast, whereas the scene depicts a skateboarding animation and the user practices gentle onset of their speech. In some embodiments, island 3 may include at least one (or a combination thereof, or all) of the following active algorithms: ASR for wrong word, voice activity detection, wrong pronunciation, too fast, disfluency detection (block, word repetition, and prolongation), and hard onset detection.

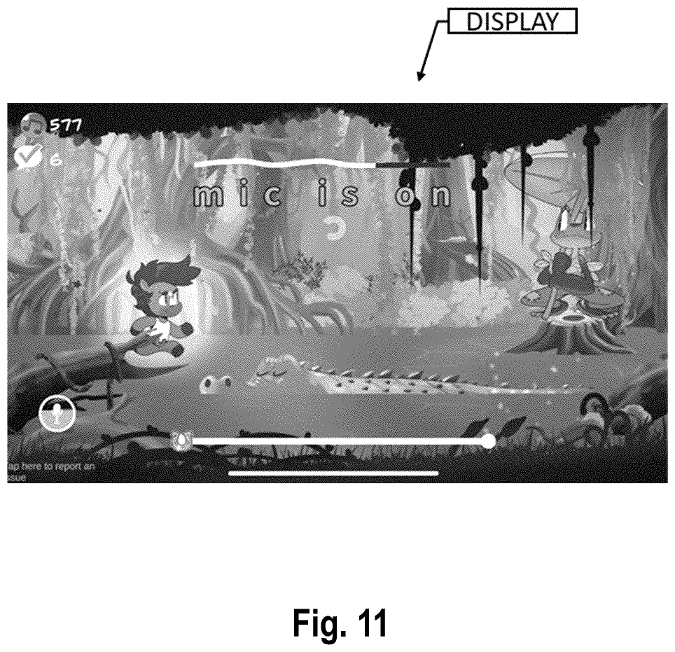

FIG. 11 generally illustrates a scene from a fourth island, or island 4, which generally is arranged for practicing slowness, whereas the scene depicts a swamp-like animation and the user practices speaking “slowly”. In some embodiments, island 4 may include at least one (or a combination thereof, or all) of the following active algorithms: ASR for wrong word, wrong pronunciation, voice activity detection, too fast, disfluency detection (block, word repetition, and prolongation), unvoiced sound, pause detection, rate of speech detection.

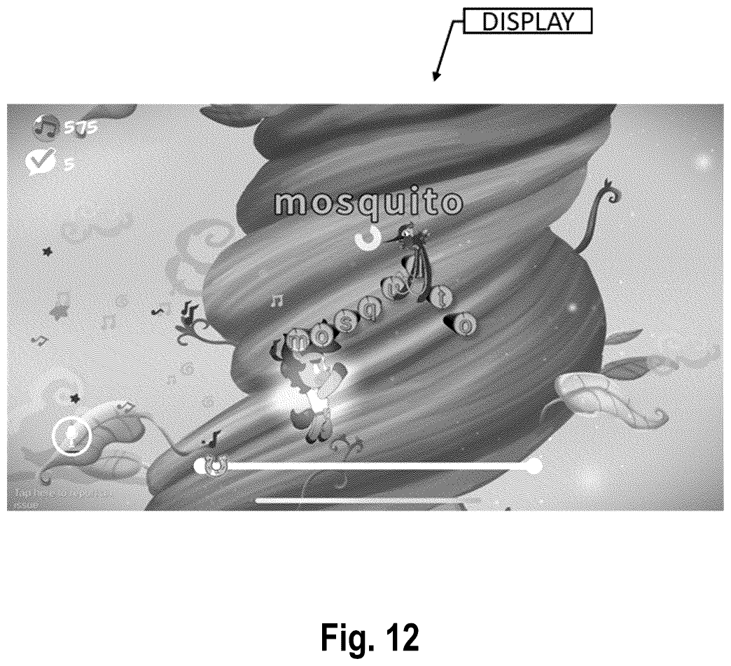

FIG. 12 generally illustrates a scene from a fifth island, or island 5, which generally is arranged for practicing pitch of speech and/or pitch changes, whereas the scene may depict a “beanstalk”. In some embodiments, island 5 may include at least one (or a combination thereof, or all) of the following active algorithms: ASR for wrong word, wrong pronunciation, voice activity detection, too fast, disfluency detection (block, word repetition, and prolongation), unvoiced sound, pause detection, pitch detection (flat pitch, pitch on the wrong part of the word or phrase).

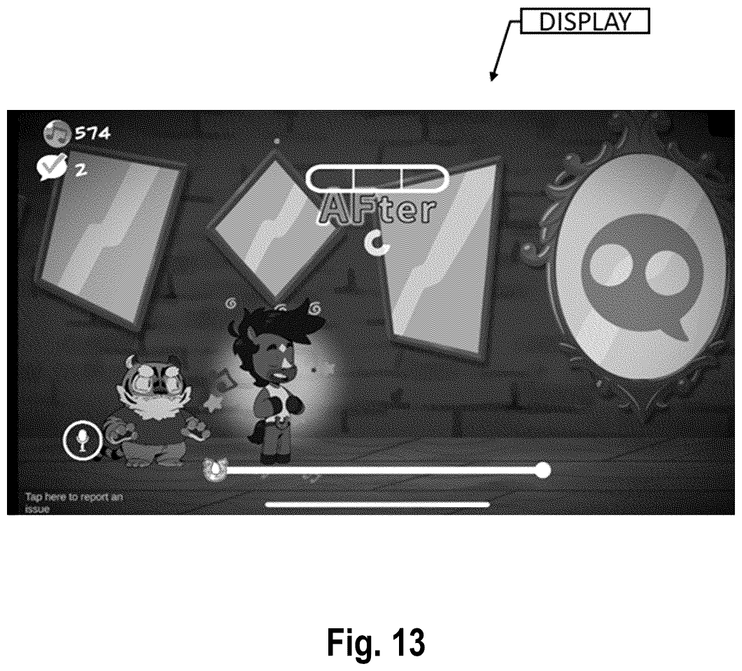

FIG. 13 generally illustrates a scene from a sixth island, or island 6, which generally is arranged for practicing speech amplitude changes, whereas the scene may depict a haunted house-like animation. In some embodiments, island 6 may include at least one (or a combination thereof, or all) of the following active algorithms: ASR for wrong word, wrong pronunciation, voice activity detection, too fast, disfluency detection (block, word repetition, and prolongation), loudness detection (too loud, too soft, loud on the wrong part of speech).

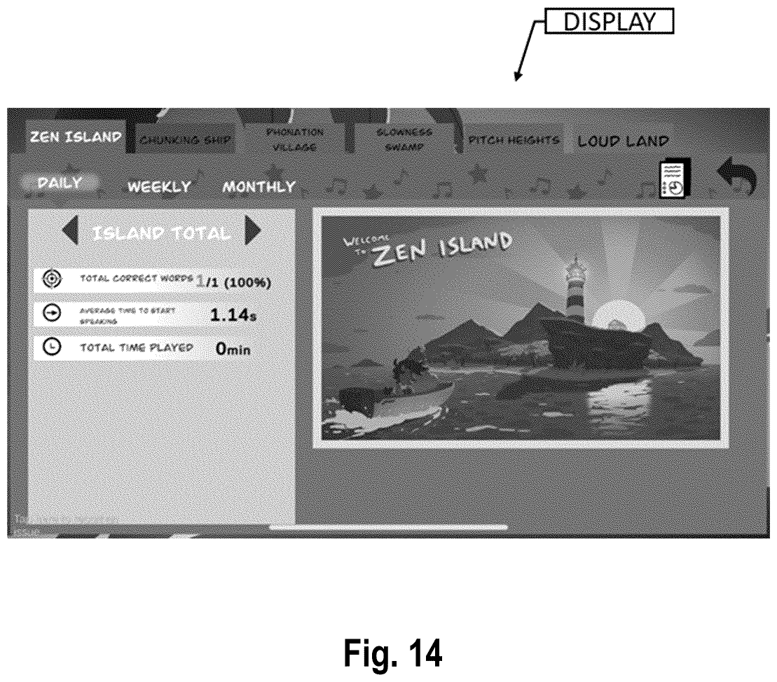

FIG. 14 generally shows a screenshot of a data view, which collects and displays data obtained from the player. Specifically, the data view shows the user exactly what they have practiced by day, week, or month—or other specified timeline, either programmable into the invention or selectable by a user input. In some embodiments, the data may include: how long a person has practiced, total correct words, incorrect words (and why), a report, etc. . . . This is organized according to a tabular index table.

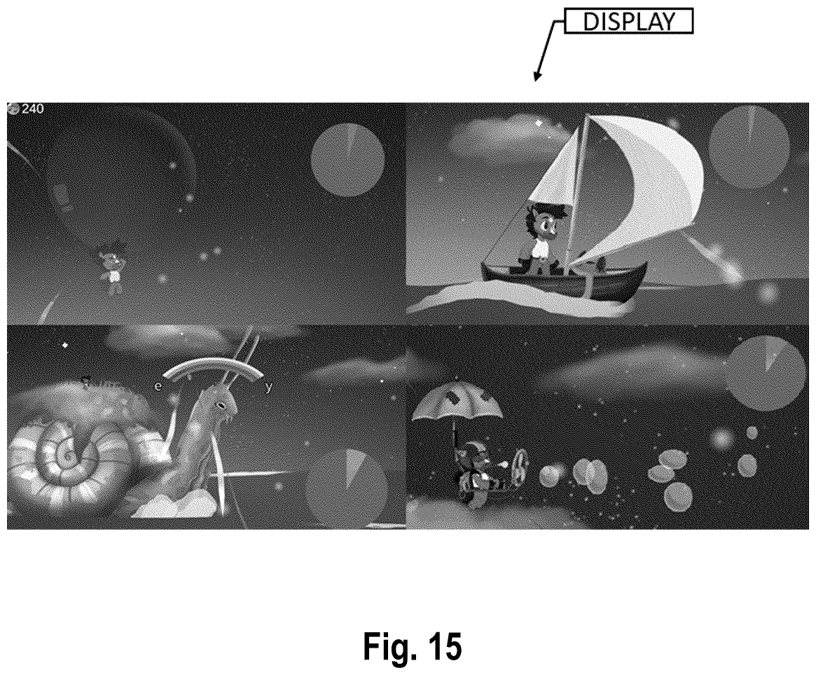

FIG. 15 generally shows a screenshot of a mindfulness exercise of the game of the invention, where the exercise generally utilizes fricative based ASR. In some embodiments, the mindfulness exercise may include at least one (or a combination thereof, or all) of the following active algorithms: pitch and voice activity detection.

It should be noted that “islands” may be considered modules, the same is true of the mindfulness exercise, and can be developed, animated, displayed, etc., in a plurality of forms. As such, the embodiments shown in FIGS. 6 through 15, are intended to be exemplary and should be taken as restrictive upon the scope of the appending claims.

The following description should be taken in view of the aforementioned disclosure and FIGS. 16 and 17, which generally depict an embodiment of a voice user interface and a respective decision tree, of the present invention. FIG. 16 generally shows the Voice User Interface. The image is a depiction of a decision tree that is designed to offer various types of feedback to the user of the present invention. The decision tree is entirely dependent on the user's specific input and/or inputs. FIG. 17 also generally shows the Voice User Interface. The image generally depicts a large decision-tree that is designed to help the user and/or users feel as though they are having a real interaction with a character during use of the game embodiment of the present invention. As such, the image illustrates a plurality of character output potentials, and has been arranged to account for the various human-computer interactions of the present invention, while the software of the present invention is programmed to ensure the interactions (i.e., user to the present invention) are unique interactions between users.

FIG. 18A-18C illustrates the speech recognition technology method for delivering speech therapy that includes the step of 1800, capturing audio voice signals by way of speech processor 112 substantially in real time on the user computer system 100 by way of at least one input system disposed on user computer system 100 wherein user computer system 100 is designed to capture, process, and analyze audio voice signals. The method further includes the step of 1805, analyzing input audio voice signals and generating speech parameters. The method further includes the step of 1810, converting speech parameters into speech data. The method further includes the step of 1815, extracting features of speech data as data variables including at least one variable indicating at least one or more of: pitch, rate of speech, speech intensity, shape of vocal pulsation, voicing, magnitude profile, pitch, pitch strength, phonemes, rhythm of speech, harmonic to noise values, cepstral peak prominence, spectral slope, shimmer, and jitter. The method further includes the step of 1820, measuring features of speech data by way of the data variables. The method further includes the step of 1825, measuring features of scoring data variables including Measures 505 from at least one or more linguistic rules from the group of: phonology, phonetics, syntactic, semantics, and morphology. The method further includes the step of 1830, computing the speech therapy assessment from the speech data. The method further includes the step of 1835, presenting one or more interactive speech exercises to users based on the speech data. The method further includes the step of 1840, providing feedback by way of the feedback processor 110 of speech processor 112.

The method may further include the step of 1845, analyzing speech data with at least one machine learning software program 115. The method may further include the step of 1850, analyzing speech data vectors by comparing positional, directional, and magnitude measurements with other speech data vectors. The method may further include the step of 1855, analyzing input speech by way of speech processor 112 and outputting speech, language, and acoustic parameters. The method may further include the step of 1860, processing the speech enhancement layer to provide at least one of: gain control, noise reduction, and acoustic echo cancellation. The method may further include the step of 1865, filtering speech data with at least one noise reduction algorithm. The method may further include the step of 1870, predicting by way of the neural network which parts of spectrums to attenuate. The method may further include the step of 1875, predicting by way of the automatic speech recognition module the sequence of text items in real time wherein the text predictions are updated based on results and variance. The method may further include the step of 1880, providing exercises and feedback by way of text, color, and movable images, such which may further be presented as games.

As would be recognized by a person skilled in the art, software of the disclosed invention can achieve results as described herein by such ways as articulation feedback in speech therapy, which focuses on helping individuals improve their pronunciation of sounds and words. Important components include auditory feedback, wherein the user receives verbal cues or uses recording devices to hear the correct production of sounds; visual feedback, wherein visual aids, such as diagrams of the mouth, tongue, and teeth positions, or video recordings, show how to produce sounds correctly; repetition and practice, wherein repeated practice of sounds, words, and sentences reinforce correct articulation patterns; positive reinforcement, wherein praise and encouragement are offered to build confidence and reinforce successful attempts at correct articulation; and corrective feedback, wherein corrections and guidance are offered when a sound is produced incorrectly, often involving showing the difference between the incorrect and correct production. Such feedback methods are tailored to the individual's specific needs and progress to ensure effective and personalized therapy, wherein the invention provides a tool to aid in such therapy.

Reverting now to articulation feedback which shall further be used to identify deviations in pronunciation, as well as phonological or phonetic errors. In order to provide effective feedback, the invention relies on a phonological knowledge approach, which is defined as linguistic-based phonological treatment approach that assumes that children's knowledge of the phonological rules of the adult system is reflected in their productions. In essence, the greater the consistency of correct sound production across varied contexts, the higher the level of phonological knowledge. The initial stages of therapy focus on sounds that reflect the least knowledge. There are also typical milestones in which the knowledge of sounds or patterns are produced. When children miss these milestones by over a year, they are generally evaluated to have a speech sound or phonological disorder.

There are over 50 known phonological disorders. Three common examples include: fronting: substituting sounds produced in the front of the mouth for sounds produced in the back of the mouth; classified as a phonological process that occurs in both normally developing children and children with phonological disorders. (e.g. “pat” for cat); cluster reduction: omission of one or more consonants of a cluster (e.g., “top” for stop); final-consonant deletion: A phonological process affecting the production of final consonants. Patterned deletion of consonant sounds in the final position of words. (e.g. “do” for dog).

The goal is to be able to detect the target sounds as well as the specific error type when one is produced. For example, given the target word “suit” where the initial/s/is the target sound, the production might be “suit” in which case the target is stimulable. Other productions can be ‘shuit” or “uit” in which case a distortion, substitution, or deletion of sound should be detected, analyzed, and displayed for the user to understand either visually, auditorily, using haptics, or a combination of these.

In some of the intended applications of the invention, the user reads a single target word that is displayed onscreen. A single word consists of a string of phonemes. Only a target phoneme or blend of up to three connected phonemes of the target word is calculated. The location of the target sound of a given word can be in the word initial, final, or middle position. The targeted phoneme(s) is/are determined by the user's selection on the user interface of the device. A device is either a computer or smartphone device such as a tablet or smartphone.

Overview:
Task is presented visually on the device to the player.
Player performs a task by speaking aloud one or more target utterances.
Corresponding speech is recorded by the device via the microphone.
Voice Activity Detector (VAD) will be activated once speech input is received.
Endpointer (EP) once the end of speech has been determined.
Speech is then processed and sent to the speech enhancement module (see module 5))
Next is detected whether there is an “out-of-domain” utterance. See definition in ‘Out-of-domain” utterance detection of this patent.
   If ‘yes’, the invention skips next processing steps and present the result to the player.
   If ‘no’, the invention assumes that the player has tried to perform the task successfully.
Next, the invention analyzes the target utterance(s) and produces a series of “pronunciation variant categories”
   There is always a “normal” category
      A normal category can contain multiple “acceptable” pronunciations, whereby acceptable can mean that an experienced speech and language pathologist (SLP) will judge the speech as correct. For example, speech sound errors that occur in positions beyond the target sound(s) may be ignored if the target sound itself is stimulable.
   All other categories correspond to a particular speech sound error also sometimes called phonological processing error or phonological error. Fronting and backing are common examples.
Next the invention calculates multiple scores for each pronunciation variant in each pronunciation variant category.
The invention optionally prune the pronunciation variants with low scores to improve robustness.
The invention then determines whether there is a pronunciation error by:
   Combining scores into a single value for each pronunciation variant
   Sorting
   Pronunciation category with highest score determines
      Whether or not there is a speech sound error
      The type of error if there is a speech sound error
For each target sound position, the invention determine the speech sound distortion
   Combine scores containing the best pronunciation variant into a single value for each target sound
      The invention only use the scores that are related to the particular target sound.
      The resulting score for each target sound is a measure of how distorted that particular target sound is.

Out-of-domain” utterance detection: An Out-of-domain (OOD) utterance for a speech recognition system refers to an input that falls outside of the expected or trained categories of speech that the system is designed to recognize or process. These utterances do not belong to the predefined vocabulary, sometimes called dictionaries.

For example an airline calling speech recognition system will be expected to handle an utterance like:
“I'd like to book a flight from New York to Los Angeles.”

However, an OOD utterance for an airline system will be an unrelated utterance such as asking the system to receive a food order.
Existing techniques for OOD detection:
   confidence scoring (for example “CONFIDENCE SCORING FOR SPEECH UNDERSTANDING SYSTEMS”)
   key-word spotting (for example “MAX-POOLING LOSS TRAINING OF LONG SHORT-TERM MEMORY NETWORKS FOR SMALL-FOOTPRINT KEYWORD SPOTTING”)
   “On Out-of-Distribution Detection for Audio with Deep Nearest Neighbors”
   exemplar scoring (for example “CONTRASTIVE LEARNING OF GENERAL-PURPOSE AUDIO REPRESENTATIONS”)
Deviant pronunciations might lower the reliability of these techniques
   The invention can use a combination of techniques
   The invention can use different model sizes. For example: first use small model, if not sure, user bigger model, etc. (example “Hey Siri: An On-device DNN-powered Voice Trigger for Apple's Personal Assistant”)
   scores→classification model→accept speech or not

Target utterance(s)→pronunciation variant categories:

A target utterance can have various pronunciation variants. This happens when an in-domain utterance (ID) is spoken but can contain various phonetic sequences. For reference, an ID utterance for a speech recognition system refers to an input that falls within the expected or trained categories of speech that the system is designed to recognize or process. These utterances do belong to the predefined vocabulary, sometimes called dictionaries. For example, “measure” in the majority of the United States is produced with a front open-mid vowel, while in the north west of the United States the vowel is produced with a diphthong.
To start, the invention analyzes the target utterance(s) and convert each word into a sequence of “base units”
   A base unit can correspond to a phoneme, word piece, syllable, word, a single character, etc. The choice of the base unit is important as it is the smallest linguistic unit the invention can give meaningful feedback on.
   Typically, this conversion is done by looking up the word in a lexicon containing the transcriptions of the word. An alternative is to use grapheme to phoneme conversion (see for example “Gi2Pi: Rule-based, index-preserving grapheme-to-phoneme transformations”); this approach is needed for words not found in the lexicon.
   In some cases, this conversion can lead to multiple sequences as a word might have multiple correct pronunciations due to regional preferences or semantic differences.
   Optionally, special base units can be inserted into these sequences depending on the type of speech recognizer. For example, at the word initial position, the base unit can be used to indicate the start of a new word. Another example is where the base unit can model an optional silence between two words or before or after the uttered speech.
Each of the unique sequences of base units are part of the so-called “normal” pronunciation variant category.
   In actual speech therapy with an SLP, it is common that a speech exercise focuses on the production of a small number of target sounds at specific positions in an utterance. Production errors at other locations might be ignored, depending on the clinician's insight or intended goal.
      To model this behavior the invention can augment the sequences of base units by copying sequences and rewriting them based on predetermined linguistic rules. For example, if the targeted focus is intended only on the initial sound of a word, if the last sound of the target word is deleted, the gestalt production may be viewed as correct.
      These rules depend on the task and exercise the player is performing.
Next, the invention produces a series of “pronunciation variant categories” based on the pronunciation sequences of the “normal” pronunciation variant category
   Rules->correspond to phonological processes
   Rules are applied to target sounds only
   Which phonological processes are relevant depend on the application of the invention

Acoustic score calculation: Next, the invention calculates a plurality of acoustic scores, at least 1 for each base unit of every pronunciation sequence that was previously generated. In the context of this invention, an acoustic score describes how well a linguistic label matches a segment of speech. Higher scores indicate therefore a better match.

To increase robustness, in some embodiments of the invention, more than 1 approach can be used to calculate these acoustic scores. Hence, each base unit of every pronunciation sequence has M types of acoustic scores associated with it.

Optionally, one can combine base units in hierarchical linguistic levels. Higher levels are combinations of base units. An example hierarchy: Base unit (phoneme), Syllable, Word, and Utterance. Acoustic scores are then also calculated for each of the corresponding higher levels by combining base units into larger segments of speech.

The acoustic scores are typically calculated based on a spectral representation (for example using 80 or 128 mel frequency bins) as input. The invention can also use prosodic features (for example pitch, duration) as input as they can be used as acoustic cues by listeners to distinguish base units (for “short” and “long” vowels in Dutch (see for example “Dutch and English listeners' interpretation of vowel duration”) or pitch movements in tone languages such as Mandarin Chinese. Formants are the resonant peaks in the spectral domain and can also be used as input.

In some embodiments of the invention, the acoustic scores can be based on the acoustic (log) likelihood of the base unit. Common automatic speech recognition architectures are HMM/GMM, HMM/DNN (see for example “Kaldi-based DNN Architectures for Speech Recognition in Romanian”), CTC-based (for example “Deep Speech 2: End-to-End Speech Recognition in English and Mandarin”), hybrid CTC/Attention (see for example “Hybrid CTC/Attention Architecture for End-to-End Speech Recognition”). A person skilled in the art will realize that reliability of such acoustic scores will be negatively influenced by the variation introduced by the articulation errors in the pathological speech. Automatic speech recognizers perform significantly worse for pathological speakers than normal speakers (see for example “Acoustic Modelling From Raw Source and Filter Components for Dysarthric Speech Recognition”).

In other embodiments of the invention an acoustic score can be based on a variant of the Goodness-of-Pronciation measure (see for example “An improved goodness of pronunciation (GoP) measure for pronunciation evaluation with DNN-HMM system considering HMM transition probabilities”).

In other embodiments of the invention, the acoustic scores are the result of classifying part of the speech signal into base units. For example, using the approaches described in “TIPAA-SSL: Text Independent Phone-to-Audio Alignment based on Self-Supervised Learning and Knowledge Transfer” or “Large-Scale Kernel Logistic Regression for Segment-Based Phoneme Recognition.” While these examples describe phoneme recognizers, a person skilled in the art will be able to extend this to other types of base units or use other types of classifiers.

In other embodiments of the invention, the acoustic scores are the inverse of an acoustic distance measure. The distance is calculated between 1 or more acoustic templates. For example, one can use the average Euclidean distance between MFCCs, or use formant values as described in “Classifying Rhoticity of / [symbol] / in Speech Sound Disorder using Age-and-Sex Normalized Formants.” Precise timing information is needed to calculate these distance measures. One can obtain this timing information by running a HMM-based recognizer in “forced alignment mode” (see example “Montreal Forced Aligner [Computer program]”) or use dynamic time warping as in “CTC-Segmentation of Large Corpora for German End-to-End Speech Recognition.”

In other embodiments of the invention, the spectral representation of the input speech is converted to a set of “articulatory” features for each frame (for example a 30 ms frame with a 10 ms frame shift). The acoustic scores are then calculated as an inverse distance between the calculated features and one or more sets of target features. The distance measure is limited to the frames corresponding to the timing of corresponding units of speech. The invention can distinguish two types of “articulatory” features:
Linguistic features: the calculated features correspond to phonological or distinctive features (see for example “Detection of Phonological Features in Continuous Speech using Neural Networks” or “Phonet: A Tool Based on Gated Recurrent Neural Networks to Extract Phonological Posteriors from Speech”).
Articulatory features: the features are estimation the positions of the articulators of speech (see for example “Preliminary inversion mapping results with a new EMA corpus” or “SELF-SUPERVISED MODELS OF SPEECH INFER UNIVERSAL ARTICULATORY KINEMATICS”)

Aggregating scores and detecting the type of articulation error: In the previous section the invention calculated the acoustic scores S_i_j_k_m_n for all base units k of the j-th pronunciation sequence of the i-th pronunciation variant category where m is the type of the cost and n representing the position of the cost in the hierarchy. The invention assume there are T number of target speech sounds that the invention are interested in.

To make the detection more robust, some embodiments of the invention can make use of two simple, but potentially effective techniques:
1. Pruning pronunciation sequences
   a. The invention can remove some pronunciation sequences if one or more scores S_i_j_k_m_n is below a given threshold.
   b. A sequence is pruned if the value of the score is lower than threshold T_i_j_m_n.
2. Biasing costs
   a. The invention can add a bias parameter B_i_j_m_n to the value of the score S_i_j_k_m_n to prime or bias the system to certain outcomes. The invention use this to mimic human behavior. For example when a listener is prompted with a text, they become more likely to recognize this text in speech.

After these steps are complete, each pronunciation sequence receives a ranking. The sequence with the highest score will then determine the pronunciation variant category and therefore the type of articulation error (if present).

The invention therefore needs to calculate a single aggregated score AS_i_j per pronunciation sequence. As there can be multiple target positions the invention follows, the invention calculates the aggregated score AS_i_j_t of the target position t and average this overall target positions 1‥T.

$$Let AS\_i \_j = sum ( AS\_i \_j \_t ) / T , with t = 1 .. T .$$

AS_i_j_t is calculated using a linear or non-linear mapping function which uses part of the acoustic scores S_i_j_k_m_n as input. To generalize and to avoid using irrelevant costs the invention only takes those costs in the immediate surroundings of the target position t into account. The mapping function should be optimized to select the pronunciation variant category which will also be selected by a human listener. A trained person can come up with various linear mapping functions (for example a weighted sum) or nonlinear mapping functions (for example based on artificial neural networks or other machine learning models.

The parameters of this mapping function can be manually set based on human knowledge and intuition or optimized automatically. The invention outline three types of approaches to train these parameters automatically:
1. The invention can create an annotated speech corpus that contains scores for each pronunciation sequence variant for each recording. Example scores can be binary (only the best receives a 1, all others a 0) or using a discrete or continuous rating scale. To optimize the parameters of the mapping function, the invention need to minimize a cost function taking these manually assigned scores and the output of the mapping function into account.
2. An alternative approach to train these interactively using genetic algorithms is outlined for example in “Efficient and reliable perceptual weight tuning for unit-selection text-to-speech synthesis based on active interactive genetic algorithms: A proof-of-concept.”
3. It is also possible to avoid perceptual ratings completely and replace them either by objective ratings which mimic the perceptual ratings (see for example “DNSMOS P.835: A NON-INTRUSIVE PERCEPTUAL OBJECTIVE SPEECH QUALITY METRIC TO EVALUATE NOISE SUPPRESSORS” as an example of such measure) or determine the ranks based on acoustic distances (see for example “Joint Target and Join Cost Weight Training for Unit Selection Synthesis”).

The optimal mapping might be dependent on language, regional differences, etiology, gender, age, or other properties of the speaker.

Estimating speech sound distortions: In clinical practice or research, speech sound distortions are typically measured perceptually on a rating scale. Common examples are a continuous scale (visual analog scale) or an ordinal scale with a fixed number of categories such as “no distortion,” “slight distortion,” “medium distortion,” “very distorted/unintelligible.” The categories of the ordinal scale can be mapped into discrete numeric values to allow mean opinion scores and to simplify further calculations.

A person skilled in the art might be tempted to use the aggregated scores AS_i_j to estimate the speech distortion at the target position i. However, these scores are optimized to mimic the selection of the best pronunciation variant category, rather than to predict speech sound distortion at a certain target position. It is however possible to create a new mapping function which maps the acoustic scores S_i_j_k_m_n to aggregated distortion scores AS_i_j_t for the target positions 1‥T. Similar to the previous section, the invention can determine the parameters of this mapping by minimizing errors between the objective and perceptual ratings, or by minimizing errors between the objective ratings and acoustic distances, which aim to mimic perpetual ratings. To improve the quality and robustness of the estimation, in certain embodiments of the invention, the previous calculation of the speech sound distortion at the target position i is modified as follows:

A binary classifier decides whether it is relevant to accurately calculate the distortion. Perceptually very large differences such as a plosive/t/that is substituted for a nasal /n/ are mapped to the lowest value of the rating. This classifier prevents outliers hampering the quality of the estimation.
In some embodiments of the invention, this classifier is rule-based, as is the case where the target sound and the pronunciation variant category as inputs are given.
A person skilled in the art will be able to create several other implementations of such a classifier, given the speech data and estimations of the timings of the relevant speech sounds in the signal as input, for example based on techniques described in “Keyword spotting—Detecting commands in speech using deep learning.”

The best pronunciation sequence is selected. This is the pronunciation sequence with the highest aggregate score.

The aggregated distortion scores AS_i_j_t for the target positions 1‥T are calculated.

The shown and described embodiments are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCES

The following list of references, i.e., references 1) through 21), are incorporated herein by reference in their entireties:
1) Nieuwboer A, Rochester L, Müncks L, Swinnen SP. Motor learning in Parkinson's disease: limitations and potential for rehabilitation. Parkinsonism Relat Disord. 2009.
2) Solomon NP, Charron S. Speech Breathing in Able-Bodied Children and Children With Cerebral Palsy. American Journal of Speech-Language Pathology. 1998.
3) Levelt, WJM. Speaking: From intention to articulation. Cambridge: MIT Press. 1989.
4) Breitenstein C, et al. Intensive speech and language therapy in patients with chronic aphasia after stroke: a randomized, open-label, blinded-endpoint, controlled trial in a health-care setting. The Lancet. 2017.
5) Valin JM. A Hybrid DSP/Deep Learning Approach to Real-Time Full-Band Speech Enhancement, Proceedings of IEEE Multimedia Signal Processing (MMSP) Workshop. 2018.
6) Talkin D. A Robust Algorithm for Pitch Tracking (RAPT). Speech Coding and Synthesis. Elsevier Science B.V. 1995.
7) Hou W et al. Exploiting Adapters for Cross-lingual Low-resource Speech Recognition. IEEE Transactions on Audio, Speech, and Language Processing (TASLP). 2021.
8) Dingliwal S et al. Prompt-tuning in ASR systems for efficient domain-adaptation. West Coast NLP Summit 2021. 2021.
9) Homayoon B. Fundamentals of Speaker Recognition. Springer-Verlag. 2011.
10) Lashi et al. Optimizing Microphone Arrays for Delay-and-Sum Beamforming using Genetic Algorithms. Proceedings of the 4th International Conference on Cloud Computing Technologies and Applications. 2018.
11) Tisserand E, Berviller Y. Design and implementation of a new digital automatic gain control. IEEE Electronics Letters. 2016.
12) Zhang G, Yu L, Wang C, Wei J. Multi-Scale Temporal Frequency Convolutional Network With Axial Attention for Speech Enhancement. Proceedings of ICASSP 2022. 2022.
13) Awad SS. The application of digital speech processing to stuttering therapy. Proceedings IEEE Instrumentation and Measurement Technology Conference Sensing. 1997.
14) Vásquez-Correa JC, Klumpp P, Orozco-Arroyave JR, Nöth E. Phonet: A Tool Based on Gated Recurrent Neural Networks to Extract Phonological Posteriors from Speech. Proceedings Interspeech 2019. 2019.
15) Dekens T, Verhelst W. Proceedings Interspeech 2011. 2011.
16) Lea C et al. Sep-28k: A dataset for stuttering event detection from podcasts with people who stutter. Proceedings of ICASSP 2021. 2021.
17) Rosenberg A. AuToBI-A tool for automatic ToBI annotation. Proceedings Interspeech 2010. 2010.
18) Middag et al. Objective intelligibility assessment of pathological speakers. Proceedings Interspeech 2008. 2008.
19) Mendoza Ramos V, Vasquez-Correa JC, Nöth E, De Bodt M, Van Nuffelen G. Automatic Score of Articulatory Distortion in Adults with Dysarthria. Available at SSRN. 2022.
20) Ravishankar S et al. Prediction of Age from Speech Features Using a Multi-Layer Perceptron Model. 11th International Conference on Computing, Communication and Networking Technologies. 2020.
21) Benesty J, Sondhi MM, Huang YA. Springer Handbook of Speech Processing. Springer. 2008.

### REFERENCE NUMBERS

100 User computer system
102 Mobile device
110 Feedback processor
112 Speech processor
114 Processor system
115 Software program
130 Server computer system
135 Processing module
202 Transceiver
204 User interface
206 Memory system
208 Location unit
206 Processor
212 Power supply
216 Microphone
218 Speaker
210 Chips
400-422 Representative method 1
300 Scripting language
302 IL2CPP Unity backend
304 Speech therapy content
306 Speech plugin
307 Game
308 Backend plugin
310 Local device
312 Remote server
314 Secured Linux server
316 PlayFab
318 Unity Analytics
500 Reports
505 Measures
510 Score
1800-1880 Representative method 2

What is claimed is:

1. A speech recognition technology system for delivering speech therapy comprising:
at least one processor system, at least one memory system, and at least one user interface disposed on at least one user computer system, the user computer system adapted to be operationally coupled to at least one server computer system;
at least one input system disposed on the user computer system adapted to, substantially in real time, capture, process, and analyze audio voice signals;
a processor system disposed on at least one or more of the user computer system and the server computer system, the processor system operating as at least one or more of a speech processor adapted to analyze input audio voice signals and generate speech parameters and a feedback processor adapted to convert measurements generated by the speech processor into speech data, the processor system adapted to present one or more interactive speech exercises to users based on the speech data, and the memory adapted to store the speech data;
at least one software program disposed on the at least one or more of the user computer system and the server computer system, the software program including at least one machine learning algorithm adapted to receive speech data from the processor, the machine learning algorithm adapted to provide users with reports, the reports adapted to provide at least one score through which to aid users at improving speaking performance;
the score including at least one variable indicating at least one or more of: pitch, rate of speech, speech intensity, shape of vocal pulsation, voicing, magnitude profile, pitch, pitch strength, phonemes,. rhythm of speech, harmonic to noise values, cepstral peak prominence, spectral slope, shimmer, and jitter; and
score assessments including measures from at least one or more linguistic rules from a group of: phonology, phonetics, syntactic, semantics, and morphology.

2. The speech recognition technology system for delivering speech therapy of claim 1, wherein the speech data includes at least one vector having positional, directional, and magnitude measurements.

3. The speech recognition technology system for delivering speech therapy of claim 2, wherein the speech data includes delta Mel Frequency Cepstral Coefficient (MFCC) vectors.

4. The speech recognition technology system for delivering speech therapy of claim 1, wherein the user computer system and the server computer system are adapted to operate as an edge computing system, further having at least one edge node and at least one edge data center.

5. The speech recognition technology system for delivering speech therapy of claim 1, further including a speech processor arranged to analyze input speech and to output various speech and language parameters, comprising:
a processor, the processor arranged with an automatic speech recognition model, the automatic speech recognition model to be loaded with at least one of:
a language model; and,
an acoustic model; and,
a microphone in communication with the processor, wherein the microphone is arranged to collect audio inputs and output the audio inputs to the processor in sequences.

6. The speech recognition technology system for delivering speech therapy of claim 5 further comprising a plurality of processing layers, each of the plurality of processing layers having at least one processing module.

7. The speech recognition technology system for delivering speech therapy of claim 6, wherein one of the plurality of processing layers comprises:
a converting layer arranged to convert the output of the microphone into a representation accepted by the processor.

8. The speech recognition technology system for delivering speech therapy of claim 7, wherein one of the plurality of processing layers comprises:
a speech enhancement layer including an algorithm arranged to provide at least one of:
automatic gain control;
noise reduction; and,
acoustic echo cancellation.

9. The speech recognition technology system for delivering speech therapy of claim 1, wherein at least one noise reduction algorithm is adapted to filter speech data.

10. The speech recognition technology system for delivering speech therapy of claim 9, further using a neural network adapted to predict which parts of spectrums to attenuate.

11. The speech recognition technology system for delivering speech therapy of claim 1, wherein an automatic speech recognition module is adapted to predict a sequence of text items in real time wherein the text predictions are updated based on results and variance from predictions.

12. The speech recognition technology system for delivering speech therapy of claim 1, further including the user interface adapted to provide feedback by way of text, color, and movable images.

13. A speech recognition technology method for delivering speech therapy comprising:
capturing audio voice signals by way of a speech processor substantially in real time on a user computer system by way of at least one input system disposed on the user computer system wherein the computer system is adapted to capture, process, and analyze audio voice signals;
analyzing input audio voice signals and generating speech parameters,
converting speech parameters into speech data;
extracting features of speech data as data variables including at least one variable indicating at least one or more of: pitch, rate of speech, speech intensity, shape of vocal pulsation, voicing, magnitude profile, pitch, pitch strength, phonemes, rhythm of speech, harmonic to noise values, cepstral peak prominence, spectral slope, shimmer, and jitter;
measuring features of speech data by way of the data variables;
scoring data variables including measures from at least one or more linguistic rules from a group of: phonology, phonetics, syntactic, semantics, and morphology;
computing a speech therapy assessment from the speech data;
presenting one or more interactive speech exercises to users based on the speech data; and
providing feedback by way of a feedback processor of the speech processor.

14. The speech recognition technology method for delivering speech therapy of claim 13, further including analyzing speech data with at least one machine learning software program.

15. The speech recognition technology method for delivering speech therapy of claim 13, further including analyzing speech data vectors by comparing positional, directional, and magnitude measurements with other speech data vectors.

16. The speech recognition technology method for delivering speech therapy of claim 13, further including analyzing input speech by way of the speech processor and outputting speech, language, and acoustic parameters.

17. The speech recognition technology method for delivering speech therapy of claim 13, further including processing a speech enhancement layer to provide at least one of:
gain control;
noise reduction; and,
acoustic echo cancellation.

18. The speech recognition technology method for delivering speech therapy of claim 13, further including filtering speech data with at least one noise reduction algorithm.

19. The speech recognition technology method for delivering speech therapy of claim 13, further including predicting by way of a neural network which parts of spectrums to attenuate.

20. The speech recognition technology method for delivering speech therapy of claim 13, further including predicting by way of an automatic speech recognition module a sequence of text items in real time wherein the text predictions are updated based on results and variance.

21. The speech recognition technology method for delivering speech therapy of claim 13, further including providing exercises and feedback by way of text, color, and movable images.
